(19) United States
(12) Patent Application Publication
(10) Pub. No.: US 2002/0120506 A1
(43) Pub. Date: Aug. 29, 2002

(54) Classified ads software program

(76) Inventor: Philip A. Hagen, Washington, DC (US)

Correspondence Address: Richard C. Litman, LITMAN LAW OFFICES, LTD., P.O. Box 15035, Arlington, VA, 22215, US

(21) Appl. No.: 10/015,698

(22) Filed: Dec. 17, 2001

Related U.S. Application Data
(60) Provisional application No. 60/255,929, filed on Dec. 15, 2000.

(51) Int. Cl. G06F 17/60

(52) U.S. Cl. 705/14

(57) ABSTRACT

A method and system for electronic classified advertising, including in a sophisticated edition, a seven-step installation wizard, portability to web servers, scalability, an intuitive and easy to use layout, customization features, fee-based options and features, ad display options and features, selected expiration of ads with optional notification, user set-up personal search agent which will automatically notify the user with new ads matching the database search criteria specified by the user, private messaging, a search engine for seven types of searches including browsing, keyword searches, retrieval of a specific ad by its database ID number, retrieval of all of a specific user's ads, retrieval of one specific ad for modification, and full database power searches, user registration, additional user posting and searching options, E-mail, Antispamming, detailed administrative controls, and security. Also available are banner ad modules, affiliate web sites, and internationalization features.

### CROSS-REFERENCE TO RELATED APPLICATION

This application claims the benefit of U.S. Provisional Patent Application Serial No. 60/255,929, filed Dec. 15, 2000.

### COPYRIGHT NOTICE

A portion of the disclosure of this patent document contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### BACKGROUND OF THE INVENTION

1. Field of the Invention

The invention relates to property transfers utilizing computer technology and, more particularly, to a method and system for automatically, electronically, independently and interactively sell, trade or exchange interests in personal, real or information property instantly using a suitable computer and an appropriate communications medium. I choose to call the invention “e-Classifieds.”

2. Description of the Related Art

There are a plethora of related art patents and publications, which are seemingly related to the instant invention. However, none offer either the wide variety of editions possible with the present invention, and none offer the flexibility of use with virtually any kind and sort of electronic programming and hardware currently available or to be developed in the future.

For example, prior U.S. Pat. No. 5,745,882, entitled “Electronic Classified Advertising Interface Method and Instructions with Continuous Search Notification”, issued Apr. 28, 1998 to Matthew J. Bixler, et al., discloses a telephone keypad interface for an electronic classified advertising system. The Bixler system necessarily requires a PSTN and the inherent limitations of a telephone keypad to operate, limitations completely absent from the instant invention.

U.S. Pat. No. 5,592,375, entitled “Computer-assisted System for Interactively Brokering Goods or Services between Buyers and Sellers” issued Jan. 7, 1997 to Bardwell C. Salnon, et al., teaches, essentially, an electronic employee bargaining marketplace, with the employer able to review in detail the qualifications of a pool of candidates. Match selection criteria is entered by the buyer. The Bardwell invention lacks the expanded capabilities of the instant invention, including the ability to be operable with any software or hardware.

U.S. Pat. No. 5,996,006, entitled “Internet-audiotext Electronic Advertising System with Enhanced Matching and Notification”, issued Nov. 30, 1999 to Gregory J. Speicher, discloses a computer based matching system including automatic advertiser notification when a suitable match is found. However, the expanded capabilities of advanced searching and matching found with the instant invention are not available from the Speicher teachings.

None of the above teachings and patents, taken singly or in combination, is seen to describe the instant invention as claimed.

### SUMMARY OF THE INVENTION

The present invention, e-Classifieds, provides up to an eight edition (currently) system and method for electronic classified advertising, including in a sophisticated edition, a seven-step installation wizard, portability to web servers, scalability, an intuitive and easy to use layout, customization features, fee-based options and features, ad display options and features, selected expiration of ads with optional notification, user set-up personal search agent which will automatically notify the user with new ads matching the database search criteria specified by the user, private messaging, a search engine for seven types of searches including browsing, keyword searches, retrieval of a specific ad by its database ID number, retrieval of all of a specific user's ads, retrieval of one specific ad for modification, and full database power searches, user registration, additional user posting and searching options, E-mail, Antispamming, detailed administrative controls, and security. Also available are banner ad modules, affiliate web sites, and internationalization features. All of these are detailed below.

Accordingly, it is a principal object of the invention to provide a fully versatile and universally useful “e-Classifieds” system and method for classified advertising which is useful with any present or future software and hardware.

It is an object of the invention to provide a fully useful “e-Classifieds” method and system which offers a full range of classifieds solutions, ranging from uncomplicated, entry-level to advanced, fully optionalized.

It is another object of the invention to provide a fully useful “e-Classifieds” method and system which is portable to differing web servers, can be custom-to-go or fully customized to meet the wishes of virtually any user, and yet provides an easy to use user interface.

It is an object of the invention to provide am electronic classifieds advertising system and method that is inexpensive, dependable and fully effective in accomplishing its intended purposes.

These and other objects of the invention will become readily apparent upon further review of the following specification and drawings.

### BRIEF DESCRIPTION OF THE DRAWINGS

FIG. 1 is a block diagram of the client architecture of the invention.

FIG. 2 is a block diagram of the web server executing the invention.

FIG. 3 is a screen printout of the navigation structure of the invention.

FIG. 4 is an exemplary form of the “Update Profile” form.

FIG. 5 is a screen printout showing the administrative control panel of the invention.

FIG. 6 is a screen printout of the set system variables section of the administrative control panel.

FIGS. 7A-7B are a screen printout of the set general variables section of the administrative control panel.

FIGS. 8A-8B are a screen printout of the set appearance variables section of the administrative control panel.

FIG. 9 is a screen printout of the set ad banner variables section of the administrative control panel.

FIG. 10 is a screen printout of the multimedia variables section of the administrative control panel.

FIGS. 11A, 11B AND 11C are a screen printout of the fee based options variables section of the administrative control panel.

FIG. 12 is a screen printout of the user registration section of the administrative control panel.

FIGS. 13A-13B are a screen printout of the set system maintenance section of the administrative control panel.

FIG. 14 is a screen printout of the backup manager section of the administrative control panel.

FIG. 15 is a flow chart illustrating the template editor.

FIG. 16 is a screen printout of the set visibility options section of the administrative control panel.

FIG. 17 is a screen printout of the set priority options section of the administrative control panel.

FIG. 18 is a flow chart illustrating the concept and creation of affiliate web sites.

FIG. 19 is a flow chart illustrating the auto-notify personal search agent.

Some figures illustrate example screen layout for input and output using a web browser interface. Underlined text represents hyperlinks. The flow charts indicate the functional component primarily responsible for carrying out a given task. The flow charts and descriptions sometimes illustrate or state that a component receives input from the end user or directs output to the end user. Simple, conventional processes are not illustrated by flow charts.

### DESCRIPTION

### DETAILED DESCRIPTION OF A PREFERRED EMBODIMENT

Anyone who uses this system and follows the process and prescribed steps can automatically, electronically, independently, and interactively trade, sell, or exchange interests in personal or real or information property instantly using a suitable computer and an appropriate communications medium. This system and method are thus useful and applicable to the field of classified advertising over electronic communications networks.

As required, a detailed illustrative embodiment of the present invention is disclosed herein. However, physical communication systems, data formats and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for claims herein which define the scope of the present invention. Numerous specific details are set forth in order to provide a thorough understanding of the present invention. It will be apparent, however, to one skilled in the art that the present invention may be practiced without some of these specific details.

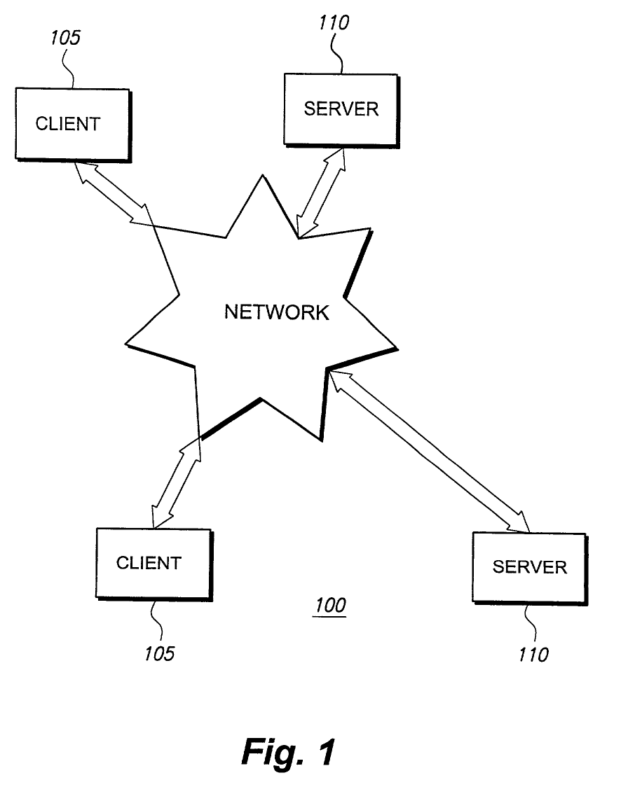

One preferred embodiment of the present invention is illustrated in FIG. 1. which is a simplified view of an exemplary client-server environment, such as the World Wide Web (the Web), in which online classified advertising may take place.

The architecture of the Web follows a conventional client-server model. The terms “client” and “server” are used to refer to a computer's general role as a requester of data (the client) or provider of data (the server). Web clients 105 and Web servers 110 communicate using a protocol such as HyperText Transfer Protocol (HTTP). In the Web environment, Web browsers reside on clients and render Web documents (pages) served by the Web servers. The client-server model is used to communicate information between clients 105 and servers 110. Web servers 110 are coupled to the Internet 100 and respond to document requests and/or other queries from Web clients 105. When an end user selects a document by submitting its Uniform Resource Locator (URL), a Web browser, such as Netscape Navigator or Internet Explorer, opens a connection to a server and initiates a request (e.g., an HTTP get) for the document. The server 110 delivers the requested document, typically in the form of a text document coded in a standard markup language such as HyperText Markup Language (HTML).

Exemplary Computer Web Server

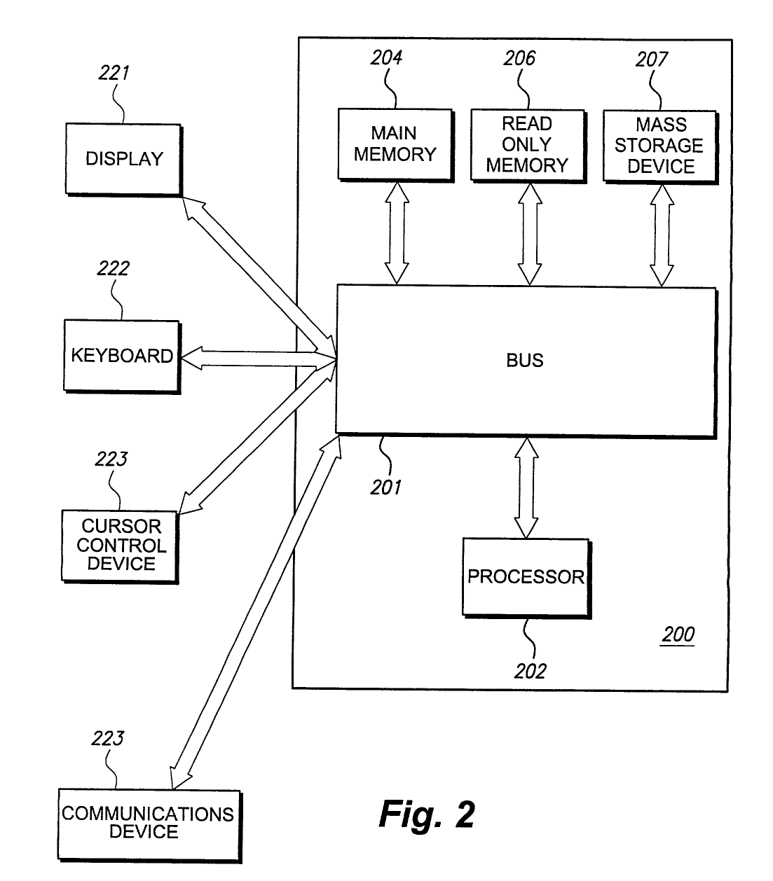

A computer web server 200 representing an exemplary server in which features of the present invention may be implemented will now be described with reference to FIG. 2. Computer web server 200 comprises a bus or other communication means 201 for communicating information, and a processing means such as processor 202 coupled with bus 201 for processing information. Computer web server 200 further comprises a random access memory (RAM) or other dynamic storage device 204 (referred to as main memory), coupled to bus 201 for storing information and instructions to be executed by processor 202. Main memory 204 also may be used for storing temporary variables or other intermediate information during execution of instructions by processor 202. An exemplary form of processor 202 is an Intel Pentium III 866 megahertz processor. Computer web server 200 also comprises a read only memory (ROM) and/or other static storage device 206 coupled to bus 201 for storing static information and instructions for processor 202.

A data storage device 207 such as a magnetic disk or optical disc and its corresponding drive may also be coupled to computer web server 200 for storing information and instructions. Computer web server 200 can also be coupled via bus 201 to a display device 221, such as a cathode ray tube (CRT) or Liquid Crystal Display (LCD), for displaying information to an end user. Typically, an alphanumeric input device 222, including alphanumeric and other keys, may be coupled to bus 201 for communicating information and/or command selections to processor 202. Another type of end user input device is cursor control 223, such as a mouse, a trackball, or cursor direction keys for communicating direction information and command selections to processor 202 and for controlling cursor movement on display 221.

A communication device 225 is also coupled to bus 201 for accessing remote servers via the Internet, for example. The communication device 225 may include a modem, a network interface card, or other commercially available network interface devices, such as those used for coupling to an Ethernet, token ring, or other type of network. In any event, in this manner, the computer web server 200 may be coupled to a number of clients and/or other servers via a conventional network infrastructure, such as a company's Intranet and/or the Internet, for example

Note that in this description, in order to facilitate explanation, the computer web server 200 is generally discussed as though it is a single device. However, Computer Web Server 200 may actually comprise multiple physical and/or logical devices connected in a distributed architecture, and the various functions performed may actually be distributed among multiple devices. Additionally, in alternative embodiments, the functions performed by the various servers may be consolidated and/or distributed differently than as described. For example, any function can be implemented on any number of machines or on a single machine. Also, any process may be divided across multiple machines.

Other physical embodiments are anticipated. For example, it is expected that future embodiments of the system will use a variety of communication devices, such as, but not limited to, Personal Digital Assistants (PDAs), internet enabled mobile phones, screen phones, facsimile machines, pagers, Network Computers (NCs), postal mail, telephone voice recognition, television, etc.

Computer Web Server 200 should contain either variants of the Unix server operating system (including Linux and FreeBSD) or Windows NT/Windows 2000 server operating systems. The server must have Perl 5 installed and functioning properly. The Administrator also must have the rights to upload files to the server using File Transfer Protocol (FTP) or some other method, and administrator must have the rights to run Common Gateway Interface (CGI) systems on the server. Some versions may also require specific Perl modules to use certain optional features such as real time credit card processing. Alternative system operating software is expected to be available.

In the preferred embodiment, the steps of the present invention are embodied in machine-executable instructions. The instructions can be used to cause the general-purpose or special-purpose processor such as the Computer Web Server 200 which is programmed with the instructions to perform the steps of the present invention.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

The instructions are contained in several types of distinct files: a main executable file named classifieds.cgi, Database files, Configuration Files, Backups of the Configuration Files, Image Files and Library Files. These instructions contained in the classifieds.cgi executable file are primarily offloaded into separately loadable libararies that are accessed only as needed. This modularization greatly enhances the speed of the system. Furthermore, The output of the system is contained in separate files from the programming code. Appendix B contains a full set of the machine executable instructions on a floppy disk.

As illustrated and described in greater detail below, the operation of this system presents unique features. The current system allows for easily customizable and configurable input and output for both administrators and end users. These customization and configuration tools are accessed from an integrated point and click web based interface. This makes the system an advancement in many areas of classified advertising such as posting and searching ads, categorization of ads and the administration of ads. While the embodiments of the system will be described with respect to an electronic classifieds application, the method and apparatus are equally relevant to other applications in which information is posted, categorized, transacted, administered and searched such as electronic message boards, electronic shopping carts, electronic auctions, electronic banner ad management, affiliate signup and tracking, electronic help desk, electronic calendars, electronic membership management, etc.

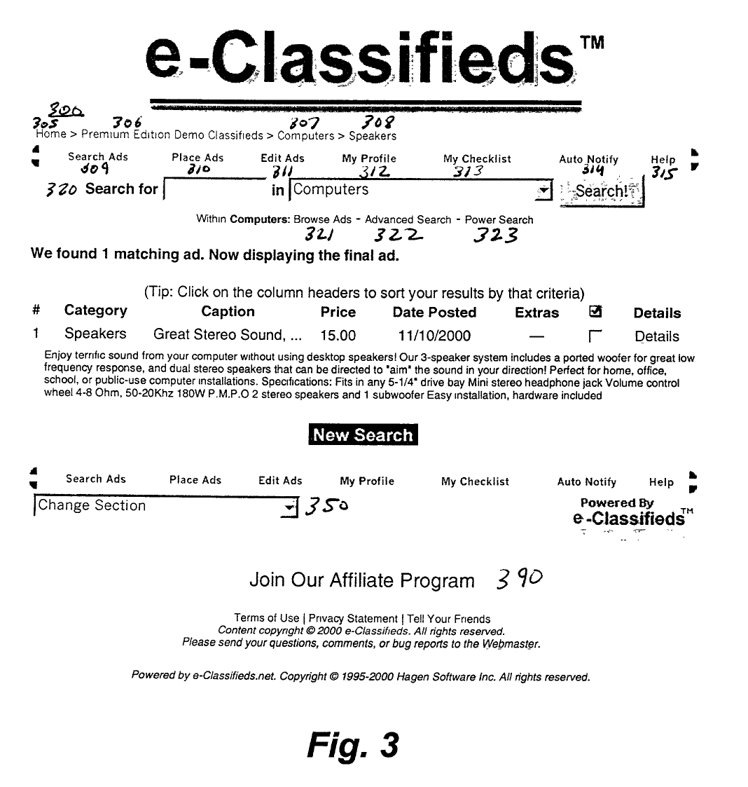

The operation of the system shown in FIG. 1 and FIG. 2 is outlined in the flow charts and illustrations of FIGS. 3-X. The operations will be presented in the typical chronological order of installation, configuration by the administrator, end user activities and maintenance by the administrator.

The principal functions that the user may request depend upon whether the user is the administrator or an end user. In the following description, it will be assumed that an administrator (also known as “admin”) sets up a web site medium in order to list items that are often found in newspaper classifieds such as tangible property (real estate, automobiles, etc.) or information. There are also non-administrative “end users” (hereinafter “end users” or “end user”) who wish to list property through this medium to other “end users” who want to interact with this property or information such as purchasing, renting, exchanging or merely viewing these items. However, the present invention is equally applicable to the purchasing, renting, viewing of any type of real or personal property such as boats, horses, to employment (i.e., listing of positions available or positions wanted), to personal ads, to the offering of services, to locating persons with specified knowledge or interests, etc.

The operation of the system is triggered by installation of the machine executable instructions.

1) Upload all files to the computer web server and create the appropriate file directories

2) Set permissions on all files and directories so that they may be able to read, write and execute as appropriately instructed.

3) Run the system from a web browser

4) A seven-step installation wizard guides the Administrator through the installation process with comprehensive web-based wizards for registration of the administrator, creating the flagship affiliate web site, defining system variables, and performing various diagnostic tests. The wizard contains progress bars to track progress and the status of installation. The installation wizard greatly reduces the likelihood of errors in setting up the system and the time involved in setup.

5) Link to the new classifieds system by pointing to the classifieds.cgi file.

Appendix A contains more detailed instructions which should be readily understood by persons in the field of computers.

Navigation of the System by an Administrator or End User 300

As illustrated in FIG. 3, all of the system functions are available from the navigation bars 300 that appear either at the top and/or the bottom of each page in default format, or along the left side of the page.

The system is navigated through a multi-tier hierarchical structure compromising a top level sections menu and lower tier categories menu(s). Above the navigation bar are links to overall site home page 305 and the system's home page 306, the current section 307 and category 308. A sections menu is also accessible from various other locations including a pull down menu 350.

The “Search Ads” link (309) takes the administrator or end user back to the front page, so that administrator or end user can search for Ads by section (category) and subcategory. The “Place Ads” link (310) allows the administrator or end user to post new Ads to the system. The “Edit Ads” link (311) allows the administrator or end user to modify Ads, renew Ads, delete Ads, or add or modify multimedia files to Ads. The “My Profile” link (312) allows the administrator or end user to register for an account or to update registration information at any time. The “My Checklist” link (313) will display all Ads that administrator has been added to the checklist (Ads that have marked for future recall and viewing by the system). The “Auto Notify” link (314) allows the administrator or end user to create, modify, or delete a personal search agent that will automatically send new Ads by e-mail that match pre-defined criteria. The “Help” link (315) will cause a pop-up help window to appear. In many areas of the system, this will contain context-sensitive help information related to the topic or page that administrator or end user is on (such as help on placing Ads when the end user is on the Ads posting form).

Beneath or within the navigation bar is a search box (320) that allows the administrator or end user to search for Ads by keywords within any or all sections. Beneath this search box are three more links. To quickly see all Ads, just click on the “Browse Ads” link. ( 321). For more advanced searches by keywords, including Boolean options, case-sensitive searching, date-range searching, and searching for Ads with photos, click on the “Advanced Search” link (322). For powerful full database searches on specific criteria and within ranges, click on the “Power Search” link (323). The navigation bar includes navigation arrows and buttons below the search results to help end users quickly jump to different sections of the search results without having to keep hitting the “Next” button.

Administration of the System

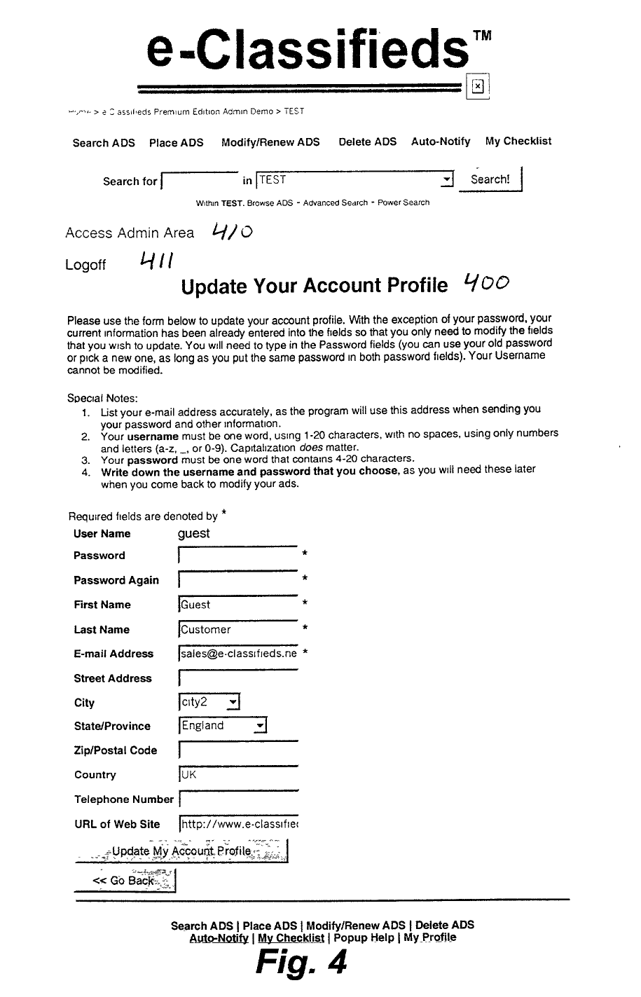

The Control Panel allows an administrator to maintain and configure all aspects of the system. The various options are divided into groups of related functions within the Control Panel. The Administrator needs to log in as the administrator to access the Control Panel and these functions. The Administrator can access the Control Panel by clicking on the “My Profile” link (312) in the navigation bar. If the administrator has not already logged in, the administrator will be prompted to do so. The administrator enters her username and password in the Logon form. After logging in, the administrator will see the “Update Profile” page (400) as illustrated in FIG. 4. The “Access Admin Area” link (410) located near the top of the page is clicked in order to access the Control Panel. Located underneath the “Access Admin Area” link (410) is a “Logoff” link (411) which provides for greater security when accessing the system at remote locations such as airports.

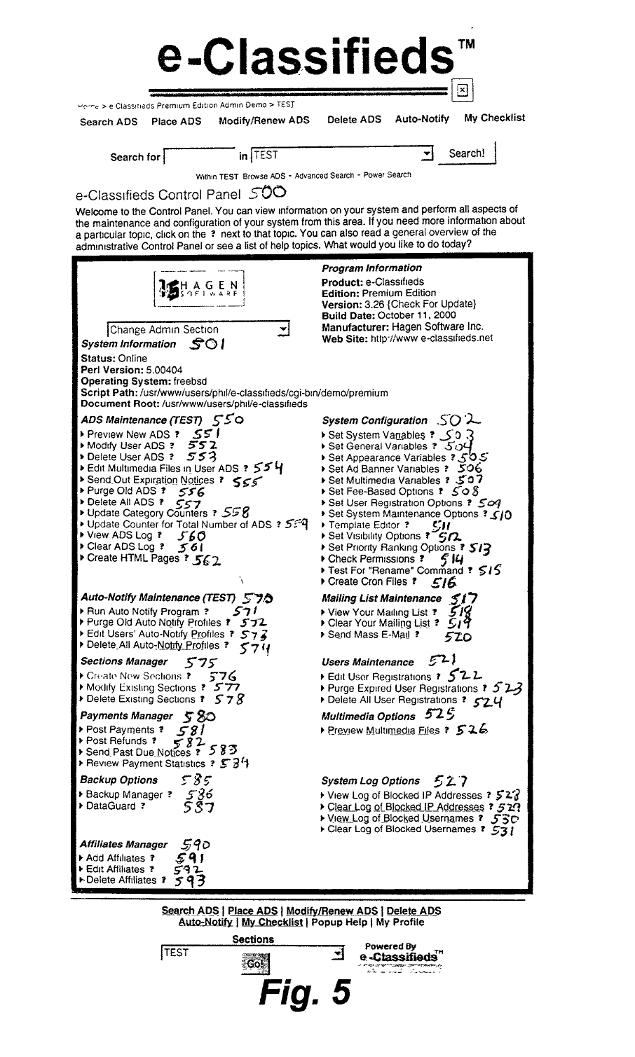

As illustrated in FIG. 5 and described in greater detail below, the Control Panel allows the administrator (and not the end user) to set system variables, general variables, appearance variables, ad banner variables, multimedia variables, fee-based options, end user registration options, and system maintenance options. It also allows the administrator to add, modify, or remove sections, edit templates, set Visibility and Priority Ranking options, perform various diagnostic tests, approve new ads posted by end users, approve new multimedia files uploaded by end users, modify any ad posted by any end user, delete any ad posted by any end user, send out expiration notices by e-mail to end users whose ads are about to expire, purge old ads, update various counters, view and clear various logs, build static HTML pages for Ads, run the Auto-Notify system, purge old Auto-Notify profiles that have expired, edit end users' Auto-Notify profiles, manage user registration database, backup important data files, add, modify, or delete affiliate web sites, view mailing list, clear mailing list, and send a mass e-mail to end users who have signed up for mailing list by clicking the checkbox on the “Post an Ad” form.

The System Information section of the Control Panel (501) provides information about the system that the administrator is using, such as the name of this version, the version number, the build date for this version. The Administrator can also check for updates to the particular version of the system by clicking on the “Check For Update” link next to the version number.

The System Configuration section of the Control Panel 502 allows the administrator to define the various settings for the system including the System Variables (503), General Variables (504), Appearance Variables (505), Ad Banner Variables (506), Multimedia Variables (507), Fee Based Options (508), User registration (509), System Maintenance (510), Template Editor (511), Visibility Options (512), Priority Ranking (513), Check Permissions (514), Test for the “rename” Command (515) and Creating Cron Files (515). The variables contained in the System Configuration section are described in greater detail below:

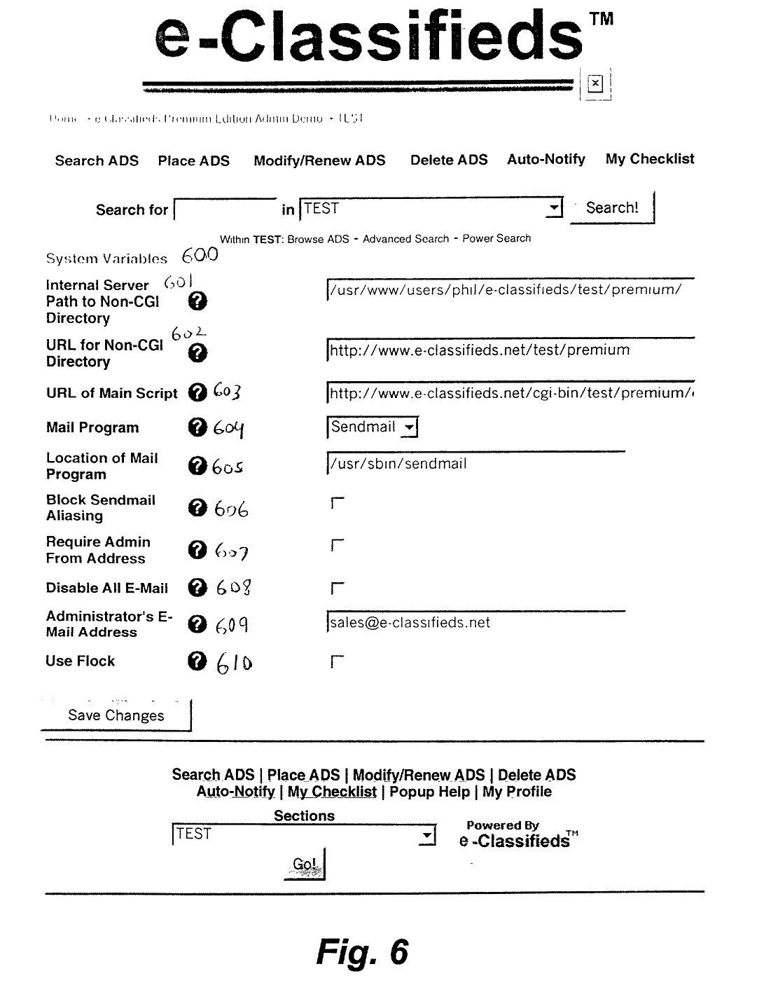

An exemplary form of the Setting System Variables Section is illustrated in FIG. 6.

Internal Server Path to Non-CGI Directory (601)

The Internal Server Path to Non-CGI Directory variable specifies the full internal server path (not a URL) to this directory that administrator created outside of cgi-bin. This is the directory that the “graphics”, “html”, “pending”, and “upload” directories should be stored beneath. These directories store the various graphic buttons and icons used by the system (the “graphics” subdirectory), the HTML pages for the ads if the administrator is using this option (the “html” subdirectory), and the multimedia files that end users upload with their Ads once the uploads have been approved by the system (the “pending” and “upload” directories). Administrator also needs to create a directory under the “html” directory for each language that administrator is using (“english” is the default directory).

URL for Non-CGI Directory (602)

The following variable should be set to the URL of the directory that administrator specified above as the location where the “graphics”, “html”, “pending”, and “upload” subdirectories are stored. Do NOT add the trailing slash at the end.

System URL (603)

This variable should point to the full URL of the main executable file (usually, the “classifieds.cgi” file).

Mail Program (604)

This variable should be set to the correct mail system for the server. There are only four valid values here:

Sendmail indicates that administrator is running on a Unix server and that administrator will be using the Unix Sendmail system.

Blat indicates that administrator is running on a Windows NT/2000 server and that administrator will be using the Blat mail system.

Windmail indicates that administrator is running on a Windows NT server and that administrator will be using the Windmail system.

SMTP (Simple Mail Transport Protocol) indicates that administrator wants to use the sockets-based e-mail subroutines. These can be used on either Unix or Windows NT web servers, provided that administrator has an SMTP mail server and that administrator has properly specified it in the Location Of Mail System variable below.

Block Sendmail Aliasing (605)

If the administrator is using the Unix Sendmail system, administrator has the option of telling sendmail not to use the alias list for the Unix server. This is a security measure to keep outsiders from using the alias list of the web server. Thus, in most cases, administrator will want to leave this set equal to “on”. If e-mail addresses are being aliased on the server, however, then administrator will need to set this equal to “ ” in order to allow aliasing.

Require Admin From Address (606)

If the administrator is having problems with certain routines (such as posting, modifying, or deleting Ads), this could be because The server does not allow outgoing e-mail messages to have a FROM address of anyone that is known to the server. If the administrative e-mail address that administrator is using for this system is known to the server, administrator can try setting the following variable equal to “on” by checking this box, and this may fix the problem.

Disable E-Mail (607)

The following variable will disable all e-mailing by the system. Normally, administrator would leave this box unchecked, but if the administrator is having problems installing the system or with certain functions, these problems may relate to the e-mail features, so administrator can temporarily turn off all e-mailing by checking this box.

Administrator's E-Mail Address (609)

The following variable specifies the e-mail address of the master administrator.

Flock (610)

If the administrator is running on a Unix/Linux server and the system supports the flock utility for file-locking, administrator should check this box. Flock should be available on almost all Unix/Linux servers. If the administrator is running on a Windows NT server, or if the administrator is not sure whether The system supports flock, administrator should uncheck this box so that the system will use its own built-in file-locking routines

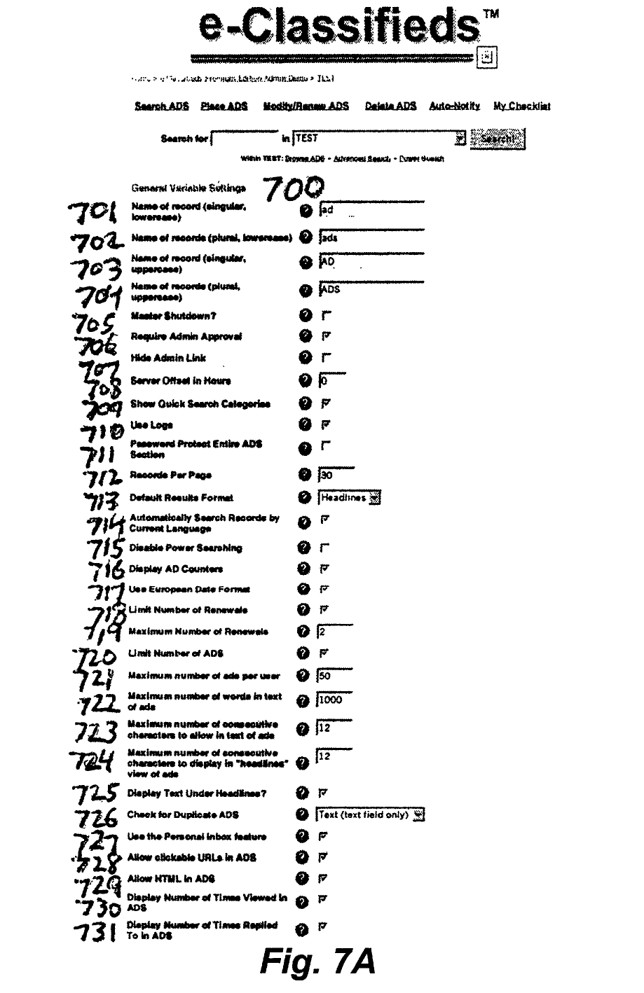

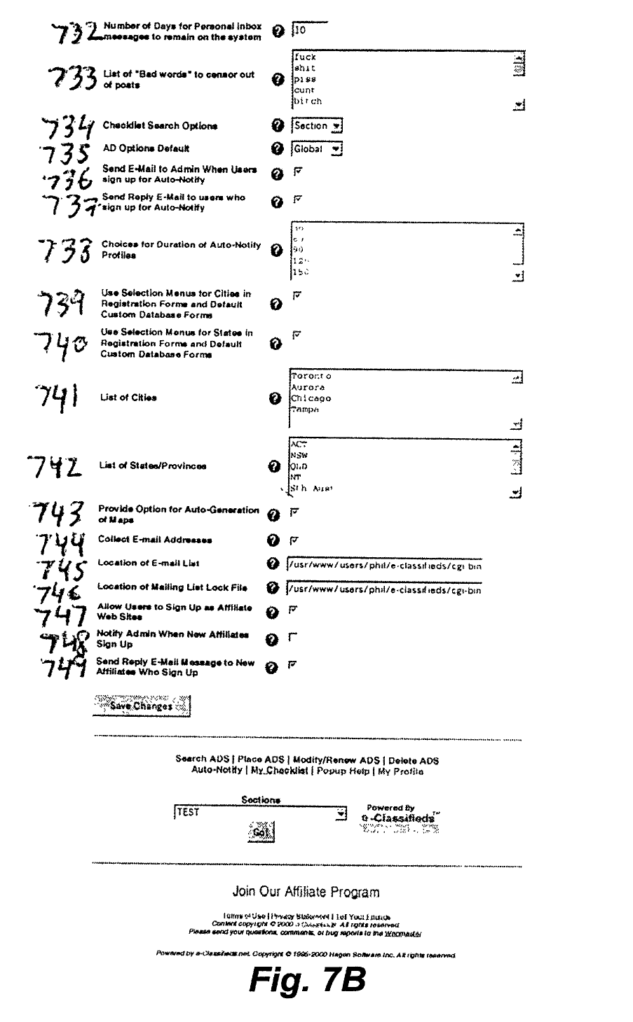

Referring to FIG. 7, Setting General Variables (700) allows an administrator to set most of the general variables, such as the name of the records, whether to use the European date format and which e-mail messages to send.

Name of Record (Singular, Lowercase) (701)

This variable specifies the singular and lower case name of the types of records in the database (such as “ad”, “movie review”, etc.).

Name of Records (Plural, Lowercase) (702)

This variable specifies the plural and lower case name of the types of records in the database (such as “ads”, “movie reviews”, etc.).

Name of Record (Singular, Uppercase) (703)

This variable specifies the singular and upper case name of the types of records in the database (such as “Ad”, “Movie Review”, etc.).

Name of Records (Plural, Uppercase) (704)

This variable specifies the plural and upper case name of the types of records in the database (such as “Ads”, “Movie Reviews”, etc.).

Master Shutdown? (705)

Normally, administrator should leave this box unchecked. If the box is checked, this will turn off the entire system. End users will simply see a message indicating that the system is temporarily down for maintenance. This option can be used this when administrator does not want end users seeing or accessing the system, such as when administrator is upgrading, editing system files, or editing important data files.

Require Admin Approval (706)

This variable for requiring administrative approval of new ads before they are viewable is turned off by default. If the administrator turns this feature on by checking the box, new ads that are posted will not show up on searches until the administrator has approved them. If this box is checked, all new Ads will be assigned a temporary status and will not be viewable by end users until they have been approved by the administrator through a special form. This form can be used to approve or delete the new Ads.

The Administrator might want to use this feature to screen new Ads before allowing them into the system, or if the administrator wants to temporarily block a spammer from flooding the system with lots of junk Ads. The downside is that administrator will have to screen the new Ads quite often, or else no new Ads will show up on system until they are approved. If the administrator does not wish to use this feature and want new ads to be displayed immediately, administrator should leave this feature turned off.

Hide Admin Link (707)

If this box is checked, the “Admin” link on the pages (if applicable for the template that administrator is using) will be hidden unless a registered admin has logged in. This hides the admin link from end users. Administrator would then access the admin area by clicking on the “My Profile” link, logging on as the admin, and then clicking on the “Access Admin Area” link. If this box is left unchecked, the “Admin” link will be displayed to all end users on certain templates, and administrator can simply click on this link to log in and go directly to the Control Panel.

Server Offset in Hours (708)

This variable can be used to modify the time obtained by the system where the time on the server varies from the local time for the intended audience. It specifies the number of hours that should be added or subtracted from the time obtained by the server when reporting the current time and date. For example, for a web site serving Australia that resides on a web server located in the United States, the system might report the current date as Tuesday, July 10, at 6:00 P.M., even though it is already 8:00 A.M. on Wednesday, July 11 in Australia. By setting this variable equal to “14” for this 14 hour difference, administrator can cause the system to report the time as the local (Australia) time of 8:00 A.M. on Wednesday, July 11. To subtract hours, simply set this variable to a negative value, such as “−3” to subtract three hours from the server time. If the administrator does not need this feature, she should leave this set to “0”. If the administrator leaves this variable blank, this will result in a error message, and the system won't run.

Show Quick Search Categories (709)

If this box is checked, the system will display a “Category” drop-down box on the Keyword Search form.

Use Logs (710)

Assuming that administrator has turned on logging by checking the box, the system maintains a log of all end user activity on the system, including posting, modifying, and deleting of ads.

These logs can be used a a method of data recovery because they are contained in the *.log files for each section (such as autos.log, employment.log, etc, depending on the section), and since they are not written to at the exact same time as the *.data files for each section (such as autos.data, employment.data, etc., depending on the section), it's possible that the *.log file for a particular section may still be intact even if the *.data file for that section was wiped out. Administrator can download the *.log file, open it up in a text editor, and turn off word-wrapping. Administrator will then see a separate line for each action, with data fields separated by the pipe symbol (the “|” symbol). The line will begin with ADD, MODIFY, or DELETE, followed by the end user's IP address. The next field is the first field of the actual ad. By stripping out the first two fields in the ADD lines (the ADD field and the IP address field), administrator can restore these ads by placing them back into *.data file for that section. The last field of each line contains the unique ad number for that ad, so when administrator is finished, administrator will want to also make sure that the number in the *.counter file for that section (such as autos.counter, employment.counter, etc., depending on the section) is higher than any of the ad numbers contained in Administrator restored *.data file. Once administrator has placed all of the ADD lines back into the *.data file, if the administrator wants to be even more thorough, he or she can do so by replacing ads that have been modified. To do so, administrator would look for the lines in the *.log file for this section that begin with MODIFY and place those ads (stripping out the MODIFY and IP address fields again) into the *.data file for this section, overwriting the ads that have the same ad numbers. Administrator could also look for ads that have been deleted (those ads in the *.log file for this section that begin with DELETE) and remove them from the *.data file.

Password Protect Entire Ads Section (711)

This variable determines whether the system will password protect the entire Ads section by requiring all end users to log on before accessing any pages. If the administrator turns this on by checking this box and also want to charge for registering, administrator should also turn on the Charge for Registering variable [see XXX below] and set the amount of the charge.

Records Per Page (712)

Administrator can change the number of Ads to be displayed per page in the search results by changing this variable.

Default Results Format (713)

This variable determines the default method for displaying the Ads when administrator conducts a search. To display them as headlines only, with a link to the full Ad, administrator should set this variable equal to “Headlines”. Otherwise, to display the full Ads by default, administrator can set this value equal to “Full Size”.

Automatically Search Records by Current Language (714)

If this box is checked, the system will automatically limit all searches conducted by end users to include only those Ads posted in the language that the system is currently being used in at the time of the search. If this box is unchecked, searches will include Ads posted in all languages unless the end user has specifically selected a language to search on in the search form.

The system has the ability to support multiple language versions of the system running simultaneously and accessing the same ads databases. The System also allows for end users to specifying the display of ads in a specific language. Multiple language feature includes double byte support for the languages such as Chinese and Japanese. Unlike traditional classified presentations, which are inherently locally or regionally based, this multiple language feature extends the system for use on a global basis.

Appendix A contains the full instructions for setting the system for multiple language support.

Disable Power Searching (715)

If this box is checked, the advanced full database searching capabilities of the system will be disabled. Normally, administrator should leave this box unchecked, but if the Ads database starts to get really large, the administrator might want to turn this on. Turning this on will not affect normal operations of the system in any way, except that end users will not be able to conduct full database searches, and the Power Search link will be removed from the toolbar.

Display Ad Counters (716)

If this box is checked, the system will display the current number of Ads in each section on the overall front page of the system, as well as the current number of Ads in each category on the front page of each section. The administrator has the option of turning this feature off. To do so, leave this box unchecked.

Use European Date Format (717)

If the administrator wants to display dates using the European format (day/month/year) instead of the standard (month/day/year) format, administrator should check this box.

Limit Number of Renewals (718)

If this box is checked, the system will limit the number of times that a specific Ad can be renewed.

Maximum Number of Renewals (719)

The following variable specifies the maximum number of times that administrator may renew his or her Ad. This is applicable only if the administrator has checked the Limit Renewals box.

Limit Number of Ads (720)

If this box is checked, the system will limit the number of Ads that can be posted under any one registered username.

Maximum Number of Ads Per End User (721)

If the Limit Ads variable above is turned on, this variable will determine the maximum number of Ads that can be posted under any one registered username.

Maximum Number of Words in Text of Ads (722)

This variable defines the maximum number of words that may be included in the Text section of each Ad. If the number of words exceeds this amount, all words after the last allowed word are stripped out from the Ad. This is useful for preventing people from writing novels in their Ads and thereby clogging up the system.

Maximum Number of Consecutive Characters to Allow in Text of Ads (723)

This variable defines the maximum number of consecutive characters to allow in the text of Ads. Words that contain more than this number of characters will be stripped into chunks containing the number of characters that administrator specifies here. This prevents someone from entering a really long line that will distort the Ad displays.

Maximum Number of Consecutive Characters to Display in “Headlines” View of Ads (724)

This variable defines the maximum number of consecutive characters that the system will display for each field in the “headlines” display format of the Ads. Fields that contain more than this number of characters will only display this number of characters, which will be followed by “ . . . ” to indicate that the field contains more characters. This helps to keep the headlines display tidy by preventing really long fields from wrapping or otherwise distorting the displays. A good default value is 20.

Display Text Under Headlines? (725)

If this box is checked, the system will display the fill text of each Ad underneath its “headlines” display.

Check for Duplicate Ads (726)

This variable has three valid values. If set to “Full”, the system will do a full database check on every field of the submitted Ad and compare this to every field in every Ad in the database. If all fields match, the system will not post the new Ad, and it will inform the end user that her Ad is a duplicate of an Ad in the database. If set to “Text”, the system will compare only the text entered into the Text or Description field to the same field for each Ad in the database. If they match, it will also check the date that the Ad in the database was posted. It will find a duplicate only if the Description text matches an Ad that was posted on the same day. Thus, while the “Text” setting is less thorough than the “Full” setting, it is also faster, which will cause the system to use fewer system resources and to post the Ads faster. If set to “None”, the system will not do any duplicate checking at all. If the administrator disables the advanced database search features using the Disable Advanced Searching variable (STEP), “full” duplicate checking will also be disabled, even if the administrator has set it here.

In general, duplicate checking is useful for preventing spammers from attempting to post multiple copies of the same Ad, or to inform people who seem to want to hit the “Submit” button several times that their Ad has already been posted.

Use the Personal Inbox Feature (727)

The Personal Inbox feature functions as a full-strength, private, and secure messaging center. Check this box if the administrator wants to hide the e-mail addresses of people who have posted Ads. Viewers will instead see a clickable link that says “Reply to Ad”. If they click on it, they will see a response form where they can enter their name, e-mail address, and brief message to send to the person who posted the Ad. That person's e-mail address is never revealed to the viewer. When an end user replies to an ad, the poster is notified that they have a reply and is given a URL where they can retrieve it. The e-mail address of the person who replied is not revealed. When the original poster retrieves the reply, he or she has the option of sending a reply back, again without revealing her or her e-mail address. That way, the parties can send messages back and forth through this system without revealing their e-mail addresses or other personal information until they feel comfortable in doing so.

If the administrator would rather just have all e-mail addresses publicly viewable, leave this box unchecked.

Allow Clickable URLs in Ads (728)

If this box is checked, the system will allow URLs that are included with the Ads to be displayed as clickable links. Otherwise, the URLs will be displayed, but they will not be clickable links.

Allow HTML in Ads (729)

If this box is checked, the system will allow end users to include HTML in their Ads. In most cases, this should probably be left unchecked.

Display Number of Times Viewed in Ads (730)

If this box is checked, the system will display a counter in each full size Ad that indicates the number of times that this Ad has been viewed in the full size format.

Display Number of Times Replied To in Ads (731)

If this box is checked, and if the administrator is using the Personal Inbox system (727), the system will display a counter that indicates the number of times that this Ad has been replied to.

Number of Days for Personal Inbox Messages to Remain on the System (732)

This variable specifies the number of days that messages will be stored in the Personal Inbox private messaging system. Messages that are older than this number of days will be deleted.

List of “Bad words” to Censor Out of Posts (733)

This variable contains the list of “bad words” that the administrator wants to prevent end users from being able to enter into their Ads. If the administrator does not want to censor end users in any way, administrator can set this blank. Administrator can also put personal names, company names, phone numbers, e-mail addresses, or other information that may be specific to an end user whom the administrator wants to block from posting Ads. Each value should be listed on a separate line.

Checklist Search Options (734)

This variable determines how the Checklist feature will work. Setting it to “Global” will cause the Checklist feature to display Ads from all Ads sections that this end user had added to her or her Checklist. While this is the most convenient option for end users, it is extremely server intensive, and it probably should not be used unless this system is running on a dedicated server that has an extremely fast processor and lots of available memory. Otherwise, administrator should probably set this to “Section”, which will cause the Checklist to search only the current section and to display checklisted Ads for this section. The third possible setting is “Off”, which will turn off the Checklist feature altogether.

Ad Options Default (735)

This variable determines how the Ad Options (Place Ads, Modify/Renew Ads, and Delete Ads) and the Auto-Notify link will work from within each section. Setting it to “Global” will cause the Ad Options and the Auto-Notify feature to always link back to a page that prompts the end user to select a section before performing this option, even if they were already inside one of the sections. The advantage of this setting is that it will help to make sure that they are posting the Ad or undertaking the action in the right section. The disadvantage of this setting is that for end users who are already in the correct section, this will require an extra step before they can post their Ads. If the administrator setsthis variable to “Section”, the Ad Options and the Auto-Notify feature will automatically link to the correct page for the section that the end user is in. Obviously, this is more convenient and saves a step, but if sections are similar, they could end up posting a new Ad in the wrong section. For example, if the administrator was operating a personals site and had created several top-level sections related to personal Ads, a male end user browsing a section called “Women Seeking Men” might erroneously post his Ad in this section, instead of posting it in the “Men Seeking Women” section.

Send E-Mail to Admin When End Users sign up for Auto-Notify (736)

Check this box only if the administrator wants the system to send an e-mail message to the administrator notifying him or her that an end user has signed up for the Auto-Notify feature.

Send Reply E-Mail to End Users who sign up for Auto-Notify (737)

Check this box only if the administrator wants the system to send a reply e-mail message to new end users who sign up for the Auto-Notify feature.

Choices for Duration of Auto-Notify Profiles (738)

This “array variable” should contain the choices for end users as to how many days their Auto-Notify search agent will remain in the system before it expires and is purged. If the administrator only want to give them one choice, then just include one value in this array. Each value should be listed on a separate line.

Use Selection Menus for Cities in Registration Forms and Default Custom Database Forms (739)

Check this box if the administrator wants the system to display a pre-defined selection menu of cities that end users must choose from when registering and when posting or searching the Ads (if the administrator is using the default “custom” posting and advanced search forms). If the administrator leaves it unchecked, they will simply enter text into a text field.

This setting will have absolutely no effect on auto-generated Ad posting and advanced search forms for each database. In other words, if the administrator has set the Cities field in the database definition file for a particular section to use a Select menu instead of a regular Text input field, and if the administrator is auto-generating the Post Ad or Advanced Search forms for that section, the settings in the database definition field will override this setting here for that particular section (e.g., a dropdown select menu using either the cities that administrator define in the database or below in the “List of Cities” variable—if the administrator is using the special %%cities%% variable in the database—will be displayed even if the administrator uncheck this box here).

Use Selection Menus for States/Provinces in Registration Forms and Default Custom Database Forms (740)

Check this box if the administrator wants the system to display a pre-defined selection menu of states and/or provinces that end users must choose from when posting or searching the Ads. If the administrator leaves it unchecked, they will simply enter text into a text field.

This setting will have absolutely no effect on auto-generated Ad posting and advanced search forms for each database. In other words, if the administrator has set the States/Provinces field in the database definition file for a particular section to use a Select menu instead of a regular Text input field, and if the administrator is auto-generating the Post Ad or Advanced Search forms for that section, the settings in the database definition field will override this setting here for that particular section (e.g., a dropdown select menu using either the states/provinces that administrator define in the database or below in the “List of States/Provinces” variable—if the administrator is using the special %%states%% variable in the database—will be displayed even if the administrator unchecks this box here).

List of Cities (741)

If the administrator turned on the Use City Selection Menu variable above, then administrator need to define the cities in this “array variable”. Each value should be listed on a separate line.

List of States/Provinces (742)

If the administrator turned on the Use State/Province Selection Menu variable above, then administrator need to define the states and/or provinces in this “array variable”. Each value should be listed on a separate line.

Provide Option for Auto-Generation of Maps (743)

If this box is checked, the system will allow end users to check a box when posting their Ad that will cause the system to automatically generate a map using a link to a mapping service. If this service does not fit the intended audience, administrator may want to leave this box unchecked. The map generation feature is applicable only in the sections where it has been activated.

Collect E-mail Addresses (744)

Check this box if the administrator wants the system to display a checkbox that allows people posting Ads to select whether they want to have their name and e-mail address added to the mailing list.

Location of E-mail List (745)

The following variable specifies the location of the text file where the names and e-mail addresses of people selecting to be added to the mailing list will be stored.

Location of Mailing List Lock File (746)

The following variable specifies the location of the lock file that will be temporarily created when the system is adding a name to the mailing list.

Referring now to FIG. 5, the Mailing List section of the Control Panel 517 allows the administrator to manage the mailing list. Administrator can view the list of subscribers to the mailing list by clicking on the View Mailing List link. Administrator can clear the mailing list and remove all subscribers by clicking on the Clear Mailing List. The administrator can send a mass e-mail message to all subscribers on the list by clicking on the Send Mass E-Mail link and then entering message in the following form.

Viewing Mailing List (518)

This option allows the administrator to view the mailing list of end users who have signed up for the mailing list by checking the signup box on the form when they posted their Ads. Each end user is listed on a separate line, with their e-mail address preceding their name. Administrator can use the “Save” feature of his or her browser to save this file and then rename it as a text file and import it into his or her regular mailing list file or even a spreadsheet system.

Clearing The Mailing List (519)

This option allows the administrator to clear the mailing list of end users who have signed up for Administrator newsletter by checking the signup box on the form when they posted their Ads. Administrator may want to clear this list periodically after administrator has viewed it using the form above and have saved the file and imported the list into Administrator regular mailing list file.

Sending Mass E-Mail to Mailing List (520)

This option allows the administrator to send a mass e-mail to Administrator subscribers who have signed up for Administrator newsletter by checking the signup box on the form when they posted their Ads.

As illustrated in FIG. 5, The System Logs Options of the Control Panel section (527) allows the administrator to view and/or clear the logs that the system creates when end users whom administrator have blocked by their IP address or username attempt to post Ads on the system.

Allow End Users to Sign Up as Affiliate Web Sites (747)

Referring back to FIG. 7, this variable specifies whether end users will be able to sign up and create affiliate web sites through an online signup form. “Affiliate” web sites are able to contribute end users and ads to the ads database, yet maintain the “look and feel” of their own web sites. There is no limit on the number of affiliates that administrator can have, provided that the web server can handle the additional traffic and number of ads that result from having all of these affiliates.

Referring back to FIG. 5, in order to set up an affiliate site, go to the Control Panel and refer to the Affiliates Manager Section 590. The Administrator will be presented with three hyperlinked options: Add Affiliates (591), Edit Affiliates (592) and Delete Affiliates (593).

By clicking on the “Add Affiliates” link (591), the Admin is presented with on-screen instructions in the online wizard. Administrator can repeat this process for additional affiliates. For each new affiliate web site, a table is created below for entering the settings. The settings to be entered are as follows:

Short Name refers to the short, one word filename that will be used internally by the program to name all files associated with this affiliate. It should be one word only, with no spaces. It must consist of only letters, numbers, or the_symbol, with no other punctuation marks. Preferably, it should use all lower case letters. This field is mandatory.

Long Name refers to the full name of this affiliate that will be displayed in references to this affiliate. This field is mandatory.

E-Mail Address refers to the e-mail address of the main administrative contact person for this affiliate. This field is mandatory.

Notify of New Ads determines whether the administrator for this affiliate will be notified by e-mail when end users post new ads through this affiliate site.

Notify of Modified Ads determines whether the administrator for this affiliate will be notified by e-mail when end users modify their ads through this affiliate site.

Notify of Deleted Ads determines whether the administrator for this affiliate will be notified by e-mail when end users delete their ads through this affiliate site.

Send Reply to End users determines whether end users who post new ads through this affiliate site will receive an automatic e-mail reply from the system.

Name of Ads Section refers to the full name of the ads section for this affiliate. This field is mandatory.

Name of Your Web Site refers to the full name of the affiliate's main web site. This field is mandatory.

Administrator's Name refers to the full name of the administrator for this affiliate. This field is mandatory.

Administrator's Title refers to the title of the administrator for this affiliate. This field is mandatory.

URL of Your Web Site refers to the URL for the main web site for this affiliate. This field is mandatory.

Slogan for Your web site refers to the slogan or byline for this affiliate. Owned By specifies the owner of this affiliate. The administrator can modify all affiliate profiles. If Administrator is allowing outside end users to set up and edit their own affiliate sites, Administrator should list the username of the owner of this new affiliate site here.

Active? refers to whether Administrator wants this affiliate to be activated immediately. If Administrator checks this box, once this affiliate has been created, it will immediately become active and visible to end users who go to the proper URL. If Administrator would rather have it be inactive temporarily, then the Administrator should leave this box unchecked.

By Clicking on Choose Affiliate to Modify (592), the Administrator is presented with a listing of affiliates. The Administrators check the radio button next to the affiliate below that is to be modified, and then clicks on the Display Modification Form button below.

The Administrator will see a page that will contain a modification form for the affiliate that is selected. This form will be filled in with the current attributes for that affiliate and will allow changing the attributes of that affiliate (the same attributes that are, listed under “Add New Affiliate”). To edit the “flagship” affiliate, choose the “default” affiliate (this is the affiliate for Administrator's main site). The “default” affiliate is highlighted in red.

By Clicking on Choose Affiliate to Delete (593), the Administrator is presented with a listing of affiliates. The Administrator checks the box next to each affiliate below that is to be permanently removed from the system, and then clicks on the Verify Affiliates to Remove button below. Removing these affiliates will remove all of their associated configuration files and customized templates (if any). The Administrator will see a confirmation page before these affiliates are permanently removed. The “flagship” affiliate is highlighted in red. There is a warning not to delete the “flagship” affiliate.

Referring back to FIG. 7, additional Affiliate System Variables:

Notify Admin When New Affiliates Sign Up (748)

This variable specifies whether the system will automatically send an e-mail notice to the administrator when new affiliate web sites sign up.

Send Reply E-Mail Message to New Affiliates Who Sign Up (749)

This variable specifies whether the system will automatically send a reply e-mail message to new affiliate web sites who sign up.

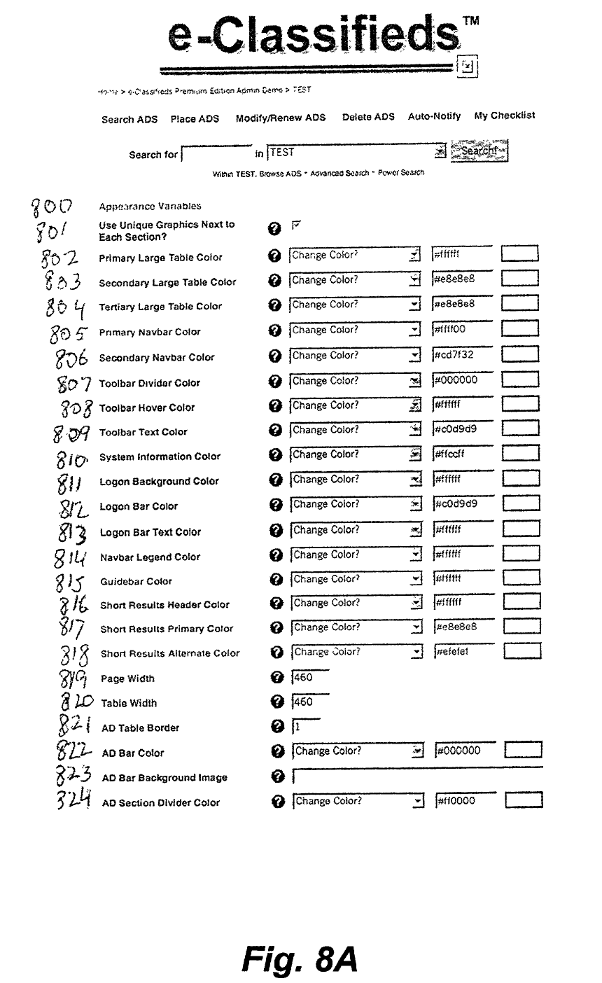

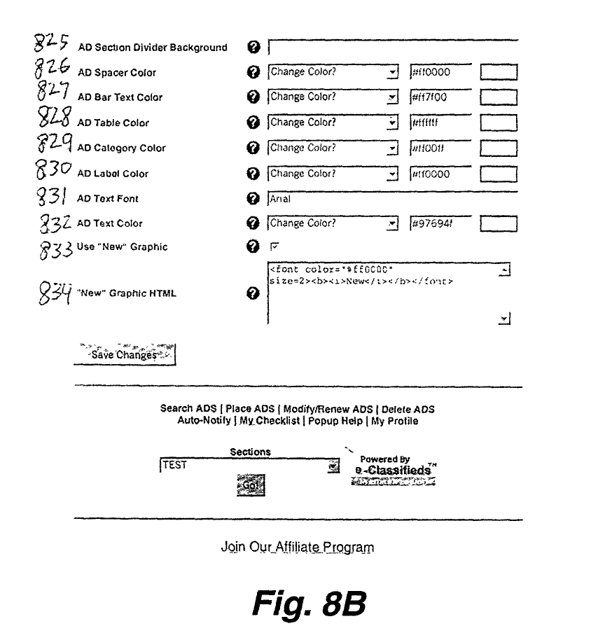

As illustrated in FIG. 8, Setting Appearance Variables (800) option allows the administrator to set the various style and appearance variables for the system, such as fonts, colors, and more.

Use Unique Graphics Next to Each Section? (801)

Check this box if the administrator wants to use unique graphics next to each section listing on the front page. If the administrator wants to use the generic folder graphic, leave this box unchecked. If the administrator checks this box, administrator needs to create a separate graphic file named “section.gif” for each section and place it in the directory that administrator have specified as the Graphics Directory, where “section” would be replaced by the internal file name that the system is using for that section (such as “autos.gif” for the Automobiles section, “employment.gif” for the Employment section, and so forth).

Primary Large Table Color (802)

This variable sets the background color for many of the forms that are displayed throughout the system. In many cases, forms on a page may alternate between the Primary Table Color and the Secondary Table Color, so if the administrator wants all forms to use the same color, administrator can set the values for both of these variables to the same color.

Secondary Large Table Color (803)

This variable sets the background color for many of the forms that are displayed throughout the system. In many cases, forms on a page may alternate between the Primary Table Color and the Secondary Table Color, so if the administrator wants all forms to use the same color, administrator can set the values for both of these variables to the same color.

Tertiary Large Table Color (804)

This variable sets the background color for a few of the forms that are displayed throughout the system, including the popup help windows and the bottom portions of the Advanced Search form. If the administrator wants all forms to use the same color, administrator can use the same value for this variable that administrator used for the Primary Large Table Color and Secondary Large Table Color variables.

Primary Navbar Color (805)

This variable sets the primary color for several of the sections in the navigation bar for the template that administrator is using.

Secondary Navbar Color (806)

This variable sets the secondary color for several of the sections in the navigation bar for the template that administrator is using.

Toolbar Divider Color (807)

This variable sets the color for the dividers in the toolbar.

Toolbar Hover Color (808)

This variable specifies the color for the toolbar when the end user is hovering over it with her or her mouse (only on newer browsers that support CS S).

Toolbar Text Color (809)

This variable sets the color for the text that appears in the dividers in the toolbar (“Ad Options”, etc.).

System Info Color (810)

This variable determines the background color for the System Info section of the administrative Control Panel (501).

Logon Background Color (811)

This variable sets the background color for the forms on the User Logon page (FIG. 4,).

Logon Bar Color (812)

This variable sets the color for the bar at the top of the forms on the User Logon page (FIG. 4,).

Logon Text Color (813)

This variable sets the color for the text that appears in the bar at the top of the forms on the User Logon page (FIG. 4,)

Navbar Legend Color (814)

This variable sets the background color for the legend that is used to explain how to use the various arrows and buttons in the navigation bar that is displayed beneath the search results.

Guidebar Color (815)

This variable sets the background color for the guidebar that shows the end user where he or she is currently located within the system.

Short Results Header Color (816)

This variable sets the color for the header bar above the table that contains the Ads in the short results (headlines) format.

Short Results Primary Color (817)

This variable sets the initial color for the rotating colors used to display Ads in the short results (headlines) format.

Short Results Alternate Color (818)

This variable sets the alternate color for the rotating colors used to display Ads in the short results (headlines) format.

Page Width (819)

The following variable determines the width in pixels for all tables, forms, and text on pages that are generated by the system. Administrator can use this, for example, to squeeze the system's output into a larger general page layout that the administrator would define in the Template Editor.

Table Width (820)

This variable should be set to the pixel width of the tables that display the Ads.

Table Border (821)

This variable determines the size of the border for each Ad.

Ad Bar Color (822)

This variable determines the color of the bar that goes across the top of each Ad and that contains the caption for that Ad. This will also be the color of the “Description” header.

Ad Bar Background Image (823)

This variable can optionally point to the URL of the background graphic that will be displayed in the bar at the top of each Ad. If the administrator specifies a background, it will override the color that the administrator chose for the Ad Bar Color variable. If the administrator wants to specify a background, the administrator should list the name of the background graphic file that administrator wants to use, and this file must be present in the “graphics” directory for the system. If the administrator does not want to use a background, administrator can simply leave this blank.

Ad Section Divider Color (824)

This variable sets the background color for the bars that divide the sections within the fill size ad display.

Ad Section Divider Background Image (825)

This variable optionally sets the background graphic for the bars that divide the sections within the full size ad display, as well as on certain other pages, such as the Control Panel. If the administrator specifies a background, it will override the color that administrator chose for the Ad Section Divider Color variable. If the administrator wants to specify a background, administrator should list the name of the background graphic file that administrator wants to use, and this file must be present in the “graphics” directory for the system. If the administrator does not want to use a background, administrator can simply leave this blank.

Ad Spacer Color (826)

This variables specifies the color of the thin line that divides some of the values in the ads.

Ad Bar Text Color (827)

This variable determines the color of the text (the subject or caption for the Ad) that is displayed in the bar at the top of each Ad.

Ad Table Color (828)

This variable determines the background color for the main portion of the table (everything except for the bar at the top).

Ad Category Color (829)

This variable determines the color of the values listed for the “Category” and “Date Posted” sections.

Ad Label Color (830)

This variable determines the color of the labels for the various fields, such as Categories, Contact, etc.

Ad Text Font (831)

This variable determines the font for all of the text contained in the Ad tables.

Ad Text Color (832)

This variable determines the color for all of the regular text contained in the full size Ads

Use “New” Graphic (833)

If this box is checked, the system will display the “New” text or graphic next to sections or categories that have items that have been posted since this end user's last visit.

“New” Graphic HTML (834)

This variable determines the HTML for the “New” text or graphic that appears next to sections or categories that have items that have been posted since this end user's last visit.

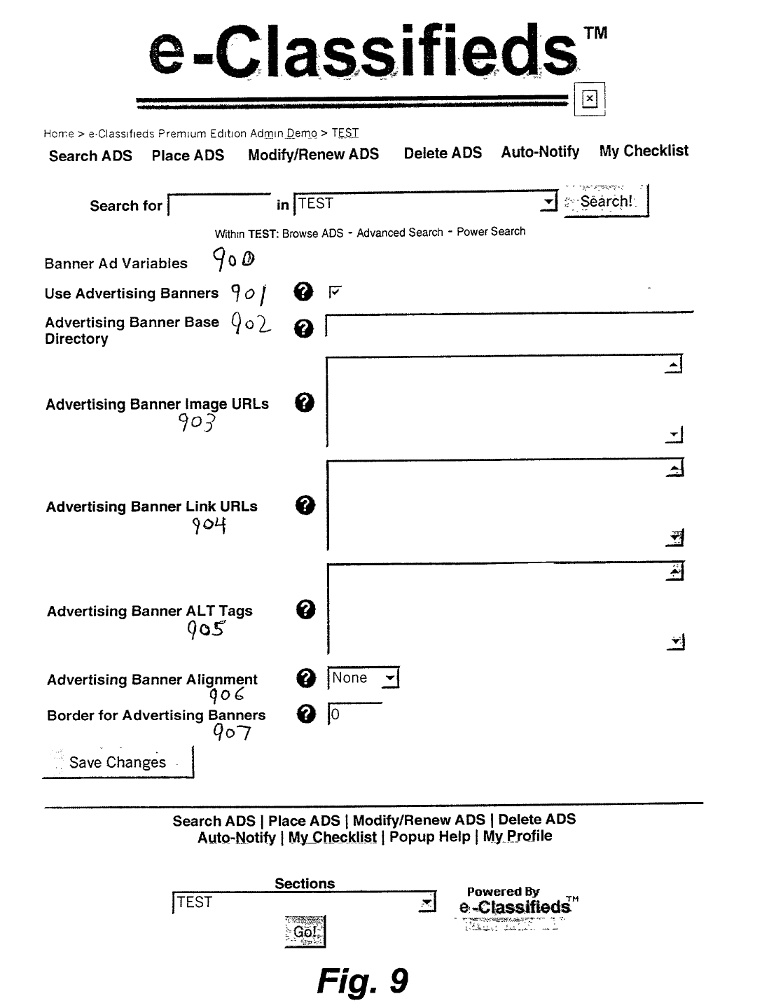

As illustrated in FIG. 9, Setting Ad Banner Variables (900) allows the administrator to specify whether he or she wants to rotate ad banners throughout the system, and if so, the images, URLs, and “alt” tags for these ad banners. Ad banners are an important form of advertising and payment for web sites.

Use Advertising Banners (901)

If this box is checked, the system will rotate banners throughout the Ads.

Advertising Banner Base Directory (902)

Set this variable to the URL of the directory where the images are stored.

Advertising Banner Image URLs (903)

This array contains the filenames for the banners that administrator wants to display. The first graphic in Images will be a link to the first URL in Urls and will display the first ALT tag in the Alt array, and so forth. Each value should be listed on a separate line.

Advertising Banner Link URLs (904)

This array contains the URLs that administrator wants to link to. The first graphic in Images will be a link to the first URL in Urls and will display the first ALT tag in the Alt array, and so forth. Each value should be listed on a separate line.

Advertising Banner ALT Tags (905)

This array contains the ALT tags that would be displayed on text-based browsers. The first graphic in Images will be a link to the first URL in Urls and will display the first ALT tag in the Alt array, and so forth. Each value should be listed on a separate line.

Advertising Banner Alignment (906)

This variable can be set to “Left”, “Center”, or “Right”, depending on how administrator wants to align the banners. It can also be left set to “None”.

Border for Advertising Banners (907)

This variable determines the size of the border around the banners. If the administrator does not want a border, then set this variable equal to 0.

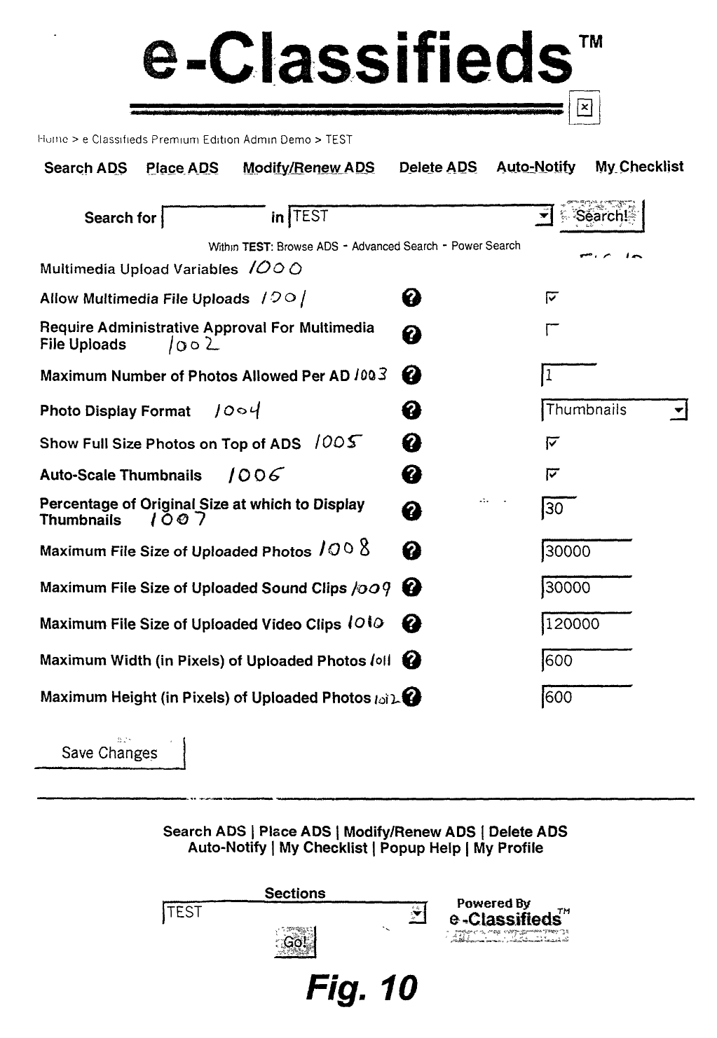

As illustrated in FIG. 10, Setting Multimedia Variables (1000) allows the administrator to set various options relating to whether administrator wants to allow end users to be able to upload multimedia files to their Ads, and if so, the file size and pixel size (for images) of these multimedia files, among other options.

Allow Multimedia File Uploads (1001)

Check this box if the administrator wants to allow users to upload photos with their Ads. If the administrator ever wants to turn this feature off and disallow photo uploads, simply uncheck this box. Turning this feature off will also cause the Ads to no longer display the photos that were previously uploaded. These photos will remain on the server until the Ads are purged or deleted, however, so they will appear with the Ads again if the administrator ever turns this feature back on.

Require Administrative Approval For Multimedia File Uploads (1002)

Check this box if the administrator wants to require administrative approval for multimedia file uploads. This option will cause uploaded multimedia files to not be immediately viewable when uploaded. Instead, they will become viewable in Ads only after they have been approved by the administrator. The advantage of this is that administrator can keep objectionable photos or other files from being included in the Ads.

Maximum Number of Photos Allowed Per Ad (1003)

This variable determines the maximum number of photos that end users can upload to each Ad. For best performance, the recommended setting is 1. Setting it to a higher number will allow end users to upload multiple photos per Ad, but this will also have the negative effects of using up more disk space and slowing down the performance of the system substantially. The higher the number, the worse the performance will become, so please be judicious in setting this.

Photo Display Format (1004)

This variable determines how the photos will be displayed in the Ads. There are four possible choices here. Setting this variable equal to “Full Size” will cause the photos to be displayed at their full size in each Ad. If the administrator is allowing large-sized photos, this could cause the display to become unwieldy. The second possible value is “Thumbnails”, which will cause the photos to be displayed as thumbnails. The size of these thumbnails will be determined by the values that administrator chooses for the Auto-Scale Thumbnails and Percentage of Original Size at which to Display Thumbnails variables below. The third possible value is “Icons”, which will cause the system to display an icon instead of the photos. Clicking on this icon (or on the photos in the first two scenarios above) will show the viewer the Ad with the full-size photo. The final possible value is “No Photo Display”, which will turn off the display of photos on the system (but end users will still be able to upload photos unless administrator has turned off the Allow Photo Uploads variable).

Show Full Size Photos on Top of Ads (1005)

Check this box only if the administrator selected “Full Size” for the Photo Display Format variable, and only if the administrator wants the system to display all of the uploaded photos above the main Ad display. This is generally not recommended, but if the administrator is allowing end users to upload large photos (larger than about 300 pixels wide or so), then administrator may want to check this box, as the displays could become unwieldy if these large photos are displayed along the left hand side of the main Ad display in the usual manner.

Auto-Scale Thumbnails (1006)

Check this box if the administrator wants the system to automatically scale the thumbnail images. It will attempt to resize the thumbnails so that they are always below 100 pixels, unless the original photo is over 500 pixels in width, in which case it will be scaled to one fifth of its original size. This variable is relevant only if the administrator set the Photo Display Format variable above equal to “Thumbnails”.

Percentage of Original Size at which to Display Thumbnails (1007)

This variable specifies the percentage of the original size that administrator wants each thumbnail to be displayed at. It should be set to an integer between 1 and 99 (in other words, for 50 percent, administrator would set this to 50, and not to 0.50). This variable is relevant only if the administrator set the Photo Display Format variable above equal to “Thumbnails” and if the Auto-Scale Thumbnails box is not checked.

Maximum File Size of Uploaded Photos (1008)

The following variable specifies the maximum size in bytes that the image files (photos) uploaded by end users can be.

Maximum File Size of Uploaded Sound Clips (1009)

The following variable specifies the maximum size in bytes that the audio files (sound clips) uploaded by end users can be.

Maximum File Size of Uploaded Video Clips (1010)

The following variable specifies the maximum size in bytes that the video files (movie clips) uploaded by end users can be.

Maximum Width (in Pixels) of Uploaded Photos (1011)

The following variable should be set to the maximum width in pixels that administrator wants to allow for photos uploaded by people posting Ads. This is important for avoiding extremely large photos that would take up too much screen space in the Ads.

Maximum Height (in Pixels) of Uploaded Photos (1012)

The following variable should be set to the maximum height in pixels that administrator wants to allow for photos uploaded by people posting Ads. This is important for avoiding extremely large photos that would take up too much screen space in the Ads.

Referring back to FIG. 5, Multimedia Options Section of the Control Panel (525) allows an admin to Preview Multimedia Files (526). If the administrator is requiring new multimedia uploads to be approved by the administrator before they are viewable, this option allows the administrator to preview all newly uploaded multimedia files that are awaiting administrative approval. For each file, administrator will have the option of approving the file, deleting the file, or deferring action until a later time. If the administrator defesr action, the file will remain in a temporary state (and thus will not be displayed to general viewers) and will be displayed again the next time that administrator run this Preview system.

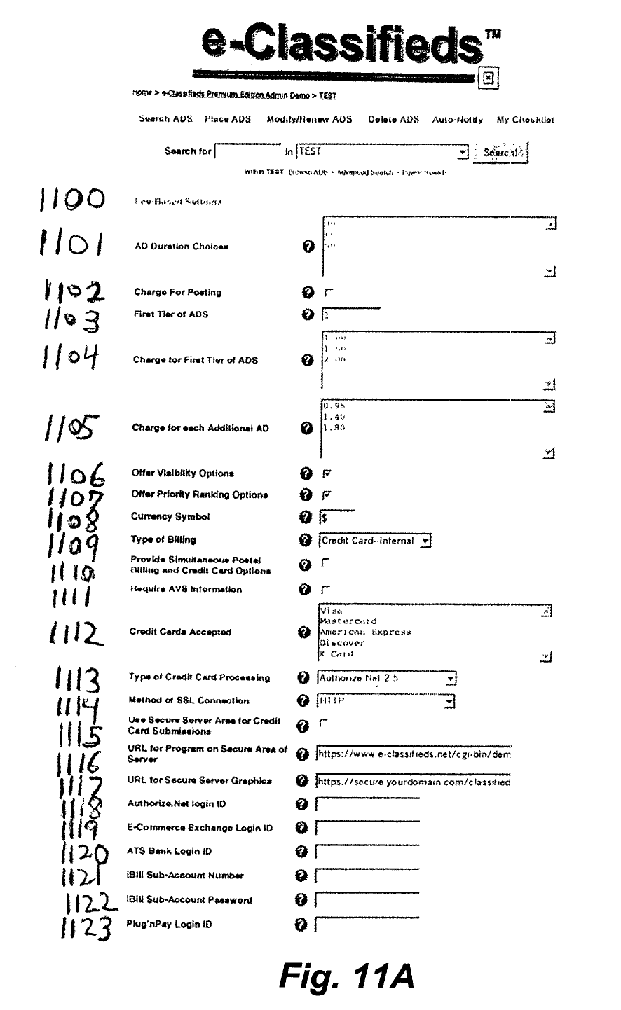

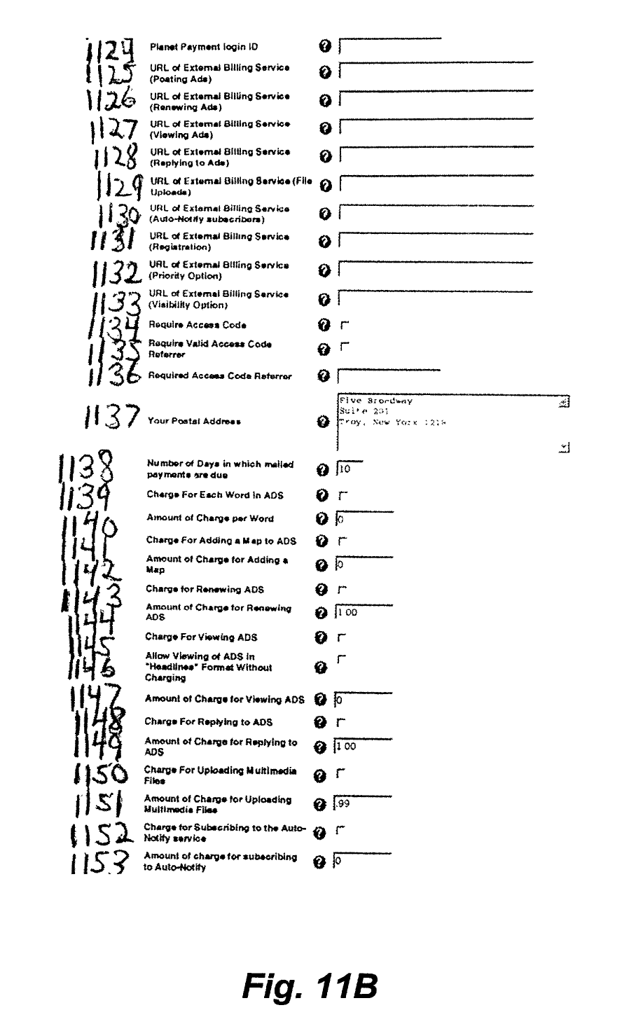

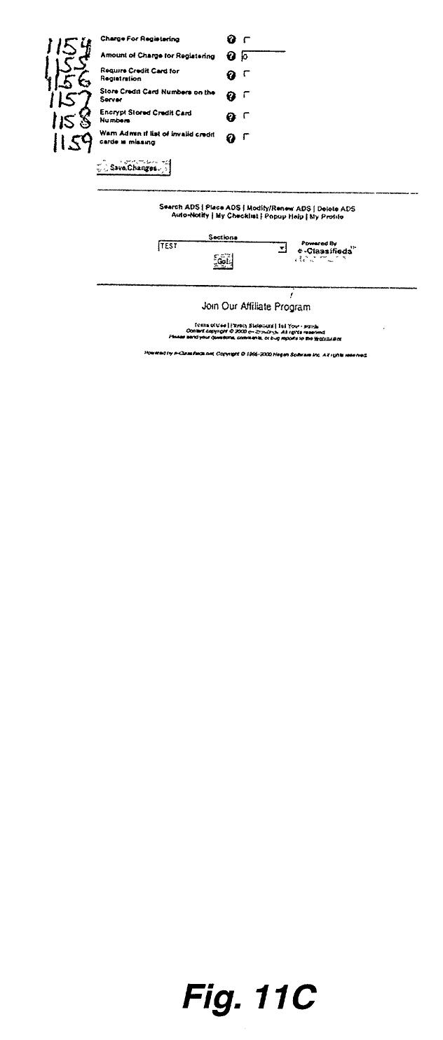

As illustrated in FIG. 11, Setting Fee Based Option (1100) allows the administrator to set the various e-commerce and fee-based options for the system.

Ad Duration Choices (1101)

This “array variable” should contain the choices for end users as to how many days their Ad will remain posted before it expires and is purged. If the administrator only want to give them one choice, then just include one value in this array. Each value should be listed on a separate line.

Charge for Posting (1102)

This box should be checked if the administrator wishes to operate a fee-based system that requires end users to pay for posting new Ads. If the administrator does not wish to charge end users for posting new Ads, then leave this box unchecked.

First Tier of Ads (1103)

This variable specifies how many Ads a user must place before receiving the rates specified below in the Charge for Each Additional Item variable. Until they post the number of Ads that administrator specifies here, they will be charged at the rates that administrator define below in the Charge for First Tier of Items variable.

Charge for First Tier of Ads (1104)

This “array variable” should contain the fees for the first group of ads posted by a registered end user. The number of items in this array should be exactly the same as the number of items in the Ad Duration Choices array above. The first item in the array below will be the cost for the first group of ads posted by an end user for the duration contained in the first item in the Record Duration Choices array above. For example, if the first item in that array is 30 (Ad displayed for 30 days), then the first item here should be the charge for Ads posted for 30 days. This will only be charged if the administrator turned on the Charge for Posting variable. Do NOT include dollar signs or any other currency symbol in front of these values, which should be numeric values only. Each value should be listed on a separate line.

Charge for each Additional Ad (1105)

This “array variable” should contain the fees for Ads posted by a registered end user who has already posted a number of Ads equal to the number that administrator set above in the First Tier of Ads variable. The number of items in this array should be exactly the same as the number of items in the Ad Duration Choices and First Ad Cost arrays above. The first item in the array below will be the cost for an Ad posted by an end user (who has already passed the first tier pricing level) for the duration contained in the first item in the Ad Duration Choices array above. For example, if the first item in that array is 30 (Ad displayed for 30 days), then the first item here should be the charge for Ads posted for 30 days. This will only be charged if the administrator has turned on the Charge for Posting variable. Do NOT include dollar signs or any other currency symbol in front of these values, which should be numeric values only. Each value should be listed on a separate line.

Offer Visibility Options (1106)

This box should be checked if the administrator wishes to offer end users the option of paying extra to have the visibility of their Ad raised. The methods of raising visibility (such as bolding Ads, etc.) and the amounts of these charges can be defined through the Visibility Options Manager in the Control Panel. If the administrator does not wish to offer any visibility raising options, then leave this box unchecked.

The Visibility Options Manager is discussed in greater detail below

Offer Priority Ranking Options (1107)

This box should be checked if the administrator wishes to offer end users the option of paying extra to have their Ads receive priority ranking in the search results. The levels or priority and the amount to charge for each level can be defined through the Priority Ranking Options Manager in the Control Panel. If the administrator does not wish to offer any priority ranking options, then leave this box unchecked.

The Priority Ranking Options Manager is discussed in greater detail below.

Currency Symbol (1108)

This variable specifies the currency unit that will be placed in front of all currency values listed by the system.

Type of Billing (1109)

This variable determines the type of billing that will be used by the system if the administrator is charging for certain functions. Set this to “Postal” for postal billing, in which the system sends an e-mail invoice to the end user requesting payment within a certain period of days (as specified in the Mail Payment Days variable). Set this to “Credit Card—Internal” if the administrator plans to use either real-time credit card processing on the backend through Authorize.Net or one of the other supported vendors, or if the administrator plan to use manual credit card processing. If the administrator is using an external billing system in which the end user enters his or her credit card information on a form maintained outside the system, such as Clickbank or other similar systems, set this to “Credit Card—External”.

Provide Simultaneous Postal Billing and Credit Card Options (1110)

This box should be checked only if the administrator selected “Credit Card—Intemal” in the Type of Billing variable above, and only if the administrator would like to offer end users the choice of paying by credit card or by check (through an e-mail invoice). This will not work if the administrator chose “Credit Card—External” in the Type of Billing variable above.

Require AVS Information (1111)

This box should be checked if the administrator is using credit card billing and want to require end users to fill out AVS information such as their address, city, state/province, zip/postal code, country, telephone number, and e-mail address.

Credit Cards Accepted (1112)

This variable specifies the credit cards that administrator will accept if the administrator is charging for certain features and if the administrator is using credit card billing. Each credit card type should be listed on a separate line.

Type of Credit Card Processing (1113)

If the administrator set the Type of Billing variable to “Credit Card”, specify in this variable the type of credit card processing that administrator will be using. If the administrator is using Authorize.Net version 2.5, set this to “Authorize.Net 2.5”. If the administrator is using Authorize.Net version 3.0, set this to “Authorize.Net 3.0”. If the administrator is using E-Commerce Exchange version 2.5, set this to “E-Commerce Exchange 2.5”. If the administrator is using E-Commerce Exchange version 3.0, set this to “E-Commerce Exchange 3.0”. If the administrator is using ATS Bank, set this to “ATS Bank”. If the administrator is using iBill, set this to “iBill”. Also, administrator must have the “basic TP” account with iBill in order to use iBill here. If the administrator is using Plug'nPay, set this to “Plug'nPay”. Set this to “Manual processing” if the administrator will not be using real-time credit card processing through one of the companies listed above. Setting this to “Manual processing” will cause the system to send administrator the end users' credit card information and/or store it on the server, depending on how administrator sets the other variables below. Administrator will then need to manually process the charges to the end users' accounts.

Method of SSL Connection (1114)

This variable determines the Secure Sockets Layer (SSL) method that the system will use to contact the secure server for Administrator outside processor. In order for this contact to be conducted over a fully secure connection, Administrator web server will need to fully support either the Net::SSLeay Perl module or the LWP::UserAgent module using a secure connection The administrator can test for each of these modules on the system by clicking on their links in the box to the right. If The server supports the Net::SSLeay module, specify the value of this variable as “Net::SSLeay”. If The server supports the LWP::End UserAgent module, including the ability of that module to make secure connections, specify the value as “LWP::UserAgent (SSL)”.

Specifying a module that is either not present or not fully implemented on The server may result in end users always seeing error messages when submitting their credit card information, or even system crashes. If The server is unable to make secure connections using either of these modules, administrator will have to specify either LWP:: UserAgent (non-SSL) here (if The server has the LWP::UserAgent module installed), or “HTTP” (provided that the server supports the Socket module). In either of these cases, the system will contact the processor's server using a standard HTTP request. This will still work in terms of posting the charges to the end user's credit card and will still be partially secure if the administrator is running the system on an SSL server, but administrator should be aware that it is not as secure as using the first two methods. Using the LWP::UserAgent (non-SSL) option requires that the LWP::UserAgent module be present on The server, and administrator can test for this by clicking on the appropriate link in the box to the right. Using the HTTP connection method requires that the Socket module be present on the server, and administrator can test for this by clicking on the appropriate link in the box to the right. If none of the first four options are available, administrator will have to select “None” here, and administrator will not be able to use the automated, real-time credit card processing features of this system. Administrator would also need to make sure that the Type of Credit Card Processing variable above (1113) is set to “Manual processing.”

Use Secure Server Area for Credit Card Submissions (1115)

This box should be checked if the administrator is using credit card billing and want to have the system use a secure (SSL) area of the computer web server when end users submit their credit card information.

URL for System on Secure Area of Server (1116)

This variable should be set to the URL of the version of the main system that the administrator installed in the secure area of the web server.

URL for Secure Server Graphics (1117)

This variable should be set to the URL of the directory that the administrator created in the secure area of the server for the storage of the system graphics. Do NOT add the trailing slash at the end.

Authorize.Net login ID (1118)

If the administrator is using Authorize.Net, the administrator should specify the Authorize.Net login ID here.

E-Commerce Exchange Login ID (1119)

If the administrator is using E-Commerce Exchange, the administrator should specify his or her E-Commerce Exchange login ID here.

ATS Bank Login ID (1120)

If the administrator is using ATS Bank, the administrator should specify his or her ATS Bank login ID here.

iBill Sub-Account Number (1121)

If the administrator is using iBill, the administrator should specify his or her iBill Sub-Account number here. This number must be the iBill Sub-Account number issued to administrator by iBill's Setup Department. This Sub-Account number consists of Administrator ibill Master Account number followed by an additional 3 digits. On occasion, ibill formats a Sub-Account with a hyphen (as in 6379-999) when displaying Sub-Accounts on screen for end users to read. When posted as a value for machines to read, a Sub-Account is always run together (as in “6379999”).

iBill Sub-Account Password (1122)

If the administrator is using iBill, the administrator should specify here his or her iBill password for the Sub-Account number that administrator listed above. Please note that this Sub-Account password is not the same as the Master password administrator is assigned along with the username by which administrator may log on to iBill's Commerce Management (CMI) server.

Plug'nPay Login ID (1123)

If the administrator is using Plug'nPay, the administrator should specify his or her Plug'nPay login ID here.

Planet Payment login ID (1124)

If the administrator is using Planet Payment, the administrator should specify his or her Planet Payment login ID here.

URL of External Billing Service (Posting Ads) (1125)

If the administrator is using an external billing system, the administrator should specify the URL of the page that the system should direct end users to when they are paying for posting a new Ad to the system (11XX XX).

URL of External Billing Service (Renewing Ads) (1126)

If the administrator is using an external billing system, the administrator should specify the URL of the page that the system should direct end users to when they are paying for renewing Ads on the system (11XX XX).

URL of External Billing Service (Viewing Ads) (1127)

If the administrator is using an external billing system, the administrator should specify the URL of the page that the system should direct end users to when they are paying for viewing Ads on the system.

URL of External Billing Service (Replying to Ads) (1128)

If the administrator is using an external billing system, the administrator should specify the URL of the page that the system should direct end users to when they are paying for replying to Ads on the system.

URL of External Billing Service (File Uploads) (1129)

If the administrator is using an external billing system, the administrator should specify the URL of the page that the system should direct end users to when they are paying for uploading multimedia files to the system

URL of External Billing Service (Auto-Notify subscribers) (1130)

If the administrator is using an external billing system, t the administrator should specify the URL of the page that the system should direct end users to when they are paying for subscribing to the Auto-Notify service.

URL of External Billing Service (Registration) (1131)

If the administrator is using an external billing system, the administrator should specify the URL of the page that the system should direct end users to when they are paying for registering as end users on the system (XX XX).

URL of External Billing Service (Priority Option) (1132)

If the administrator is using an external billing system, the administrator should specify the URL of the page that the system should direct end users to when they are paying for priority ranking for a new Ad on the system. If the administrator is using an outside service, administrator can set only one fee and one fee-based priority ranking option (11XX XX).

URL of External Billing Service (Visibility Option) (1133)

If the administrator is using an external billing system, please specify the URL of the page that the system should direct end users to when they are paying for the fee-based portions of the system. If the administrator is using an outside service, administrator can set only one fee and one fee-based visibility option.

Require Access Code (1134)

If the administrator is using an external billing system, and if Administrator vendor allows the administrator to set up a return URL for a “confirmation” page after successful credit card transactions, administrator should set up their system to point to the special URL for this system and check this box.

That way, the system will create a special data file and access code that the end user will need to enter on the payment form before their transaction (posting a new Ad, uploading a photo, etc.) will be processed. This helps to ensure payment. Otherwise, or if the vendor doesn't offer this feature, administrator will have to leave this box unchecked. Administrator will also need to manually verify that payment has been received for each service or transaction, since the system will have no way of performing this verification beforehand, since it will have no way of knowing whether the end user successfully posted the credit card payment. This is similar to the type of post-transaction verification that would be necessary if the administrator were using postal billing via e-mail invoices.

Require Valid Access Code Referrer (1135)

If the administrator is using an external billing system, if Administrator's vendor allows the administrator to set up a return URL for a “good” page after successful credit card transactions, if the administrator has set up their system to point to the special URL for this system, and if the administrator checked the Require Access Code box above, then administrator may want to check this box. Checking this box will cause the system to require that the referring URL be from the credit card vendor in order to create the special access code for the end user. If the administrator knows the referring domain name of the vendor, administrator probably should check this box, as it provides extra security in that it prevents end users from creating bogus access codes by simply entering the right URL. If the administrator checks this box, then administrator must specify the valid referring domain in the variable below.

Required Access Code Referrer (1136)

If the administrator has checked the Require Valid Access Code Referrer variable above, and if the administrator know the domain name of the server where Administrator vendor will be referring users back to the administrator from, administrator should enter that domain name here. This provides extra security in that it prevents end users from creating bogus access codes by simply entering the right URL.

Administrator Postal Address (1137)

This variable should contain the postal address where administrator wants end users to mail their payments for various actions that they have taken if the administrator is operating a fee-based system and are using postal billing instead of credit card billing.

Number of Days in which Mailed Payments are Due (1138)

This variable specifies the number of days in which end users who have posted Ads on Administrator's site must mail in their payments to the address above.

Charge for Each Word in Ads (1139)

Check this box only if the administrator wants to charge end users by the word for each word contained in Ads that they post. Otherwise, leave it unchecked.

Amount of Charge Per Word (1140)

If the administrator is charging end users for each word contained in Ads that they post, this variable should specify the charge per word. Do NOT include dollar signs or any other currency symbol in front of these values, which should be numeric values only.

Charge for Adding a Map to Ads (1141)

Check this box only if the administrator wants to charge end users for adding a map to Ads that they post. Otherwise, leave it unchecked.

Amount of Charge for Adding a Map (1142)

If the administrator is charging end users to add a map to their Ads, this variable should specify the charge for each Ad that they add a map to. Do NOT include dollar signs or any other currency symbol in front of these values, which should be numeric values only.

Charge for Renewing Ads (1143)

This variable specifies whether or not the system will charge end users who renew their Ads. To enable charging for renewals, check this box. Otherwise, leave this box unchecked.

Amount of Charge for Renewing Ads (1144)

If the administrator has enabled charging for renewals by checking the box above, this variable specifies the amount of the charge. Do NOT include dollar signs or any other currency symbol in front of this value, which should be a numeric value only.

Charge for Viewing Ads (1145)

Check this box only if the administrator wants to charge end users for viewing Ads. Otherwise, leave it unchecked.

Allow Viewing of Ads in “Headlines” Format Without Charging (1146)

Check this box if the administrator has turned on the Charge for Viewing Ads variable above but only wants to charge for viewing the full-size Ad, while still allowing end users to see the short results format Ads (“headlines”). If the administrator wants to charge for both formats, leave this box unchecked.

Amount of Charge for Viewing Ads (1147)

If the administrator is charging end users to view Ads, this variable should specify the charge for allowing end users to view Ads for a subscription period equal to the number of days that administrator specified in the Registration Expiration Days variable. Do NOT include dollar signs or any other currency symbol in front of these values, which should be numeric values only.

Charge for Replying to Ads (1148)

Check this box only if the administrator wants to charge end users for replying to Ads on the system (this requires that administrator also set the Use Personal Inbox variable equal to “on”, because otherwise, the e-mail addresses themselves will be visible). If the administrator does not wish to charge for replying to Ads, leave this box unchecked.

Amount of Charge for Replying to Ads (1149)

If the administrator is charging end users to reply to Ads, this variable should specify the charge for allowing end users to reply to Ads for a subscription period equal to the number of days that administrator specified in the Registration Expiration Days variable (11XX XX). Do NOT include dollar signs or any other currency symbol in front of these values, which should be numeric values only.

Charge for Uploading Multimedia Files (1150)

Check this box only if the administrator wants to charge end users for uploading multimedia files (photos, sound clips, or video clips) to their Ads. If the administrator does not wish to charge for uploading multimedia files, leave this box unchecked.

Amount of Charge for Uploading Multimedia Files (1151)

This variable should specify the fee to be charged for each uploaded multimedia file (photo, sound clip, or video clip). This will be activated only if the administrator has set the Charge for Uploading variable equal to “on” (11XX XX). Do NOT include dollar signs or any other currency symbol in front of this value, which should be a numeric value only.

Charge for Subscribing to the Auto-Notify Service (1152)

Check this box only if the administrator wants to charge end users for subscribing to the Auto-Notify personal search agent (11). If the administrator does not wish to charge for the Auto-Notify feature, leave this box unchecked.

Amount of Charge for Subscribing to Auto-Notify (1153)

This variable should specify the fee to be charged for each Auto-Notify search agent that administrator sets up. This will be activated only if the administrator has set the Charge For Auto-Notify variable equal to “on”. Do NOT include dollar signs or any other currency symbol in front of this value, which should be a numeric value only.

Charge for Registering (1154)

This variable determines whether the system will charge end users who register. If the administrator turns this on, the administrator should set the amount of the registration charge in the Amount of Charge for registering variable below (11XX). This charge will be for a subscription period equal to the number of days that administrator specifies in the Registration Expiration Days variable below.

Amount of Charge for Registering (1155)

If the administrator is charging end users to register, this variable should specify the charge for allowing end users to register for a subscription period equal to the number of days that administrator specifies in the Registration Expiration Days variable (11XX XX). Do NOT include dollar signs or any other currency symbol in front of these values, which should be numeric values only.

Require Credit Card for Registration (1156)

If this box is checked, the system will require end users who register to enter their credit card information. Depending on the values that administrator set for the variables below, this information will either be e-mailed to the admin when the end user registers, or it will be stored on the server in a file (administrator can set encryption for this file below).

Store Credit Card Numbers on the Server (1157)

If this box is checked, the system will store the credit card numbers and other information entered by end users who register in the user registration database. Unless administrator is on a secure server (and probably still even then), administrator will also want to turn on the Encrypt Credit Card variable. This feature is active only if the administrator has turned on the Require CC For Registration variable above.

Encrypt Stored Credit Card Numbers (1158)

If this box is checked, the system will encrypt end users' credit card numbers that are stored in the user registration database for fee-based systems.

Warn Admin if List of Invalid Credit Cards is Missing (1159)

If this box is checked, the system will e-mail administrator a warning when it can't find the stolen card list file.

As illustrated in FIG. 5. the Payments Manager section of the Control Panel (580) allows the administrator to record payments that the administrator has received for Ads posted on the system, record refunds that administrator has issued, send past due notices to end users who have not paid for their Ads on time, and review payment statistics.

Posting Payments Received (581)

This option allows the administrator to record payments that administrator has received from end users who have posted Ads.

Recording Refunds (582)

This option allows the administrator to record refunds that administrator has issued to end users who have posted Ads.

Sending Past Due Notices (583)

This option allows the administrator to send past due notices to end users who have posted Ads on the system and have not paid their invoices on time.

Reviewing Payment Statistics (584)

This option allows the administrator to review various payment statistics, including revenues from new Ads and renewals, current receivables and any past due receivables as well as any refunds that administrator may have issued.

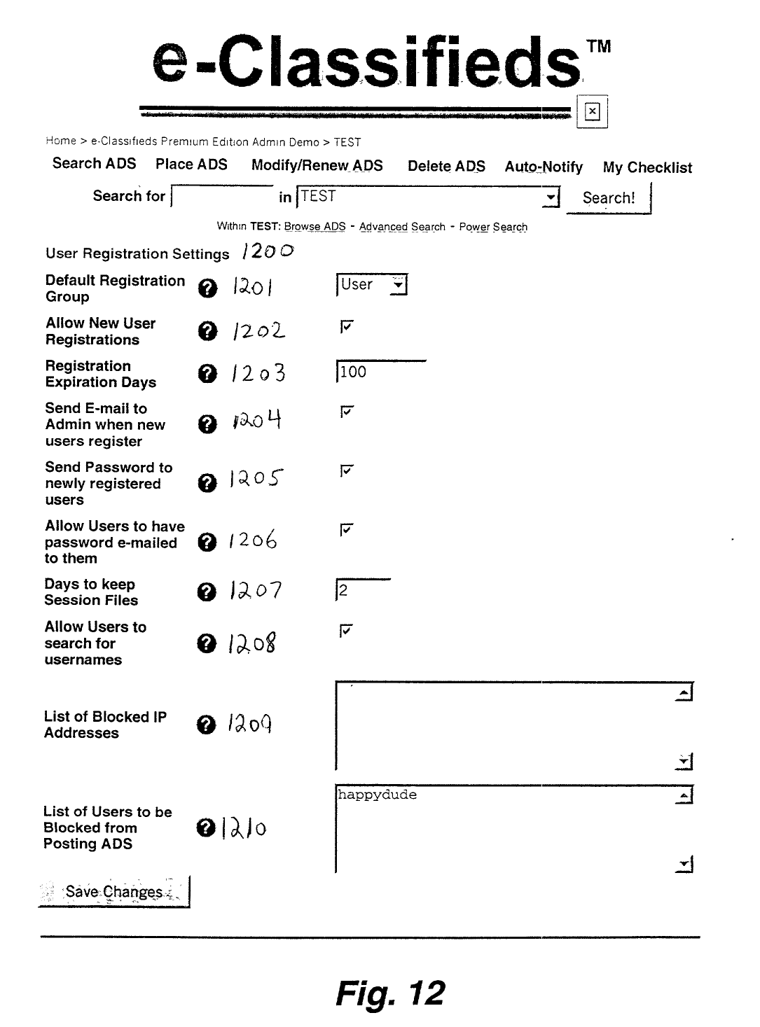

Referring to FIG. 12, End user Registration Options (1200) allows the administrator to set various options related to the end user registration system.

Default Registration Group (1201)

This variable specifies the default group for new end users who register. This should normally be set to “User”. If the administrator wants to register another administrator, the administrator can set this to “Admin”, save the changes, and register the new user as the admin. The original Administrator should then immediately go back to the User Registration settings form and change this setting back to “User”. Otherwise, the administrator risks giving outside end users “administrator” status. Thus, this aspect of the system allows for multiple tiered end user registrations (including multiple classifieds administrators) with unique privileges for each.

Allow New User Registrations (1202)

This variable determines whether new end users can register. This normally should be turned on by checking this box, but administrator can turn it off (by unchecking this box) if the administrator does not want to allow registrations. Unchecking the box results in the the “Register for Account” link not being displayed on the logon form.

Registration Expiration Days (1203)

This variable specifies the number of days before user registration expires if there is no activity. This number should be set to a higher number of days than the highest value that administrator set for the Ad Duration variable, because administrator doesn't want to purge the registration information for users who still have current Ads in the system.

Send E-mail to Admin when New Users Register (1204)

If this box is checked, the system will e-mail the admin whenever someone registers as administrator.

Send Password to newly registered users (1205)

If this box is checked, the system will e-mail a welcome notice to new users that includes their username and password.

Allow Users to Have Password e-mailed to Them (1206)

If this box is checked, the system will allow users who forget their passwords to have them e-mailed to them based on their username, and it will add a link for this purpose to the logon form.

Days to Keep Session Files (1207)

This variable specifies the number of days that session files should be kept before they are automatically deleted.

Allow Users to Search for Usernames (1208)

If this box is checked, the system will allow users to be able to search for their username based upon their e-mail address. Unchecking it will remove the “Forgot username” link on the logon form.

As illustrated in FIG. 5, User Registrations Section of the Control Panel (521), the Editing End user Registrations (522) option allows the administrator to edit the registration information for any of users. This includes modifying any of their information or deleting their registration altogether.

The Purging Expired User Registrations (523) option allows the administrator to purge all end users from the registration database whose accounts have had no activity within the past 120 days, as specified in the global configuration variables. Administrator might want to run this system periodically if user registration database (contained in the default users file in the “users” subdirectory) becomes large.

The Delete All End user Registrations (524) option allows the administrator to delete all users from the registration database.

Referring back to FIG. 12,

List of Blocked IP Addresses (1209)

This “array variable” contains the list of IP addresses of users that administrator wants to block access to. If the administrator does not want to block access to any users, administrator can leave this blank. Since some users may have dynamic IP addresses (IP addresses that are different each time they logon to the Internet), administrator may want to set this equal to the first 3 sections of digits of their IP address (such as 111.222.333 for an IP address of 111.222.333.444).

List of Users to be Blocked from Posting Ads (1210)

This “array variable” contains the list of user names that administrator wants to block access to. If the administrator don't want to block access to any users, administrator can leave this blank. The system will compare the user names specified here against the session user name of the current user (which is the user name that they specified when registering) and prevent that user from posting new Ads if there is a match. Each value should be listed on a separate line.

As illustrated in FIG. 5, System Logs Option of the Control Panel (527),

View Log of Users Blocked by IP Address (528)

This option allows the administrator to view the log of failed attempts to post new Ads by users whose IP addresses were blocked. Each failed attempt is listed on a separate line, with the content of their failed Ad contained on that line. Administrator can use the “Save” feature of his or her browser to save this file. If there are no entries in this log, administrator may see a blank screen or receive a “Document contains no data” message

Clear Log of Users Blocked by IP Address (529)

This option allows the administrator to clear the log of failed attempts to post new Ads by users whose IP addresses were blocked. Administrator may want to clear this log periodically after administrator has viewed it using the form above.

View Log of Users Blocked by Username (530)

This option allows the administrator to view the log of failed attempts to post new Ads by users whose usernames were blocked. Each failed attempt is listed on a separate line, with the content of their failed Ad contained on that line. Administrator can use the “Save” feature of Administrator browser to save this file. If there are no entries in this log, administrator may see a blank screen or receive a “Document contains no data” message.

Clear Log of Users Blocked by Username (531)

This option allows the administrator to clear the log of failed attempts to post new Ads by users whose usernames were blocked. Administrator may want to clear this log periodically after hoe or she has viewed it using the form above.

System Maintenance

As illustrated in FIG. 5, the Set System Maintenance Options section of the Control Panel (510) allows the administrator to set various options related to the maintenance of the system, such as which routines should be run automatically, at what intervals, and other variables related to these settings. There are several different ways that administrator can activate these features, although the preferred and easiest method is to use the system's built-in routines. The system can automatically run its own built-in category counter (STEP), total ad counter (STEP), warn (STEP), purge (STEP), Auto-Notify (STEP), Auto-Notify purge (STEP), user purge (STEP), HTML page creation (STEP), backup (STEP), and DataGuard (STEP) routines at periodic intervals. These can be set up very easily by checking the appropriate boxes and setting a few of the other related variables, such as the intervals during which these routines should be run.

Another option is to manually run these routines periodically from Administrator's browser by accessing the Control Panel. Many of them must be run for each section, so the administrator will need to go to each section and access the Control Panel again to run these systems for a particular section.

A third option is to run these routines as Unix “cron” jobs. Cron is a feature of Unix servers that can be set to automatically run certain routines at specific times. Its main advantages are that administrator can set the routines to be run at precise times, knowing that they will always run at that time, regardless of whether Administrator's classifieds section is getting any traffic. They also are less likely to slow down the response times of the system for end users. Running these routines as cron jobs also has several disadvantages, however. First, cron can be extremely complicated to set up, and it may not even be available on the server. For example, Windows does not have this feature, so Windows servers will have to use one of the other methods outlined above. Another disadvantage of cron is that if the administrator wants to run all of these routines as cron jobs for all sections, administrator would need to set up dozens and dozens of different cron jobs with the default setup, and even more if the administrator adds additional sections. However, unlike other known maintenance systems, this system, make this easier for the administrator by adding a “Create Cron Files” option in the Control Panel (516) as shown in FIG. 5. This creates all of these cron files for administrator automatically and place them in the “cron” subdirectory, including the correct extension to use on the computer web server (.cgi, pl, etc.), the correct path to Perl 5, and the correct internal server path to the classifieds.cgi file

These routines are discussed in greater detail below:

Interval in Days between Running the Expiration Notice System (1301)

This variable specifies the minimum number of days in between each time that administrator wants to run the “warn” system that sends out warning notices to those end users whose Ads are about to expire. That way, it won't be run more often, causing unnecessary system overhead for the server and causing users to receive multiple, annoying e-mail messages. If the administrator is running the warn system as a cron job, the value here should be exactly the same as the number of days in between each time that administrator is running the cron job. In other words, if it runs each day, this value should be set equal to “1”. If it runs once a week (every 7 days), this value should be set equal to “7. It is suggested that administrator run the cron job once a day and set the value here equal to “1”.

Minimum Number of Days to Warn of Impending Ad Expiration (1302)

This variable sets the minimum number of days before each end user's Ad is about to expire that the system should send this end user the e-mail notice warning him or her of the imminent expiration of this Ad. If the administrator is able to run the “warn” system daily (either as a cron job, manually, or because Administrator site gets enough traffic that the system will be run in each section on each day so that the built-in warn system for that section is run each day) and thus have set the Warn Runtime Interval variable below equal to “1 ”, then all of users will receive this warning notice exactly on the number of days before the Ad expires that administrator specifies here.

Use the Built-in Automatic Sending of Ad Expiration Notices (1303)

This box should be checked only if the administrator is not using the separate WARN.PL file and administrator cannot or do not want to have to manually run the warn system each day. If this is set to “on”, the system will periodically warn end users whose Ads are about to expire (the interval depends on the number of days that administrator specifies in the Warn Runtime Interval below). If the administrator is running Unix and have access to “cron” jobs, we strongly suggest administrator use cron to automatically run the warn.???.pl files to send out the warning notices and that administrator leaves this box unchecked. This is because the built-in version will cause additional server overhead and may not run at the exact time periods that administrator like because it is dependent on user actions (it can run only when the system is actually being used). As a result, some users may not receive warning notices before their Ads expire. Therefore, administrator should check this box only if the administrator has no other choice and cannot or does not want to manually run the warn system on a regular, periodic basis (meaning every 3 days, every 7 days, etc.).

Interval in Days between Running the Purge System (1304)

This variable specifies the minimum number of days in between each time that administrator wants to run the “purge” system that purges all Ads that are older than the number of days that administrator specified in the variable. That way, it won't be run more often, causing unnecessary system overhead for the server. If the administrator is not sure how to set this, we suggest that administrator leaves it set equal to “1”.

Use the Built-in Automatic Purging of Old Ads (1305)

This box should be checked only if the administrator is not using the separate PURGE.PL file and administrator wants the system to automatically purge Ads that have expired. If the administrator is running Unix and has access to “cron” jobs, we strongly suggest administrator use cron to automatically run the purge.???.pl files to purge old Ads and that administrator leaves this box unchecked. This is because the built-in version will cause additional server overhead and may not run at the exact time periods that administrator like because it is dependent on end user actions (it can run only when the system is actually being used).

Interval in Days between Running the System that Updates the Category Counters (1306)

This variable specifies the minimum number of days in between each time that administrator wants to run the “category counter” system that counts the number of Ads that are placed in each category and updates the display of these numbers on the front page of each section. That way, it won't be run more often, causing unnecessary system overhead for The server. If the administrator not sure how to set this, we suggest that administrator leaves it set equal to “1”.

Use the Built-in Category Counter Update System (1307)

This box should be checked only if the administrator is not using the separate CATCOUNT.PL file and administrator wants the system to automatically update the category counters for each section. If the administrator is running Unix and have access to “cron” jobs, we strongly suggest administrator use cron to automatically run the catcount.???.pl files to update the category counters and that administrator leaves this box unchecked. This is because the built-in version will cause additional server overhead and may not run at the exact time periods that administrator like because it is dependent on end user actions (it can run only when the system is actually being used).

Interval in Days between Running the System that Updates the Section Counters (1308)

This variable specifies the minimum number of days in between each time that administrator wants to run the “total counter” system that counts the total number of Ads that have been placed in this section and updates the display of this number on the overall front page of the system. That way, it won't be run more often, causing unnecessary system overhead for the server. If the administrator is not sure how to set this, we suggest that administrator leaves it set equal to “1”.

Use the Built-in Section Total Counter Update System (1309)

This box should be checked only if the administrator is not using the separate TOTALCOUNT.PL file and administrator wants the system to automatically update the counters for the total number of Ads in each section. If the administrator is running Unix and has access to “cron” jobs, we strongly suggest administrator use cron to automatically run the totalcount.???.pl files to update the section total counters and that administrator leaves this box unchecked. This is because the built-in version will cause additional server overhead and may not run at the exact time periods that administrator like because it is dependent on user actions (it can run only when the system is actually being used).

Interval in Days between Running the System that Converts the Ads to HTML Files (1310)

This variable specifies the minimum number of days in between each time that administrator wants to run the “dbtohtml” system that converts the Ads to HTML files. That way, it won't be run more often, causing unnecessary system overhead for The server. If the administrator is not sure how to set this, we suggest that administrator leaves it set equal to “1”.

Use the Built-in DBtoHTML Conversion System (1311)

This box should be checked only if the administrator is not using the separate DBTOHTML.PL file and administrator wants the system to automatically convert the Ads to HTML files periodically. If the administrator is running Unix and have access to “cron” jobs, we strongly suggest administrator use cron to automatically run the dbtohtml.???.pl files to convert the Ads to HTML files and that administrator leaves this box unchecked. This is because the built-in version will cause additional server overhead and may not run at the exact time periods that administrator like because it is dependent on end user actions (it can run only when the system is actually being used).

Purge End Users Runtime Interval (1312)

This variable specifies the minimum number of days in between each time that administrator wants to run the end user purge system. That way, it won't be run more often, causing unnecessary system overhead for The server. If the administrator' is not sure how to set this, we suggest that administrator leaves it set equal to “1”.

Use Builtin Purge of Old End Users (1313)

This box should be checked only if the administrator is not using the separate END USERPURGE.PL file and administrator wants the system to automatically purge end users who have had no activity for a specific period of days (as defined in the Registration Expiration Days variable) and who are not currently signed up for Auto-Notify in any of Administrator sections.

As illustrated in FIG. 5, if the administrator has had the system create backups periodically, and if these are still intact, administrator can restore from these backups through the Control Panel (585). The Administrator has the option of restoring whole backups or individual files from these backups.

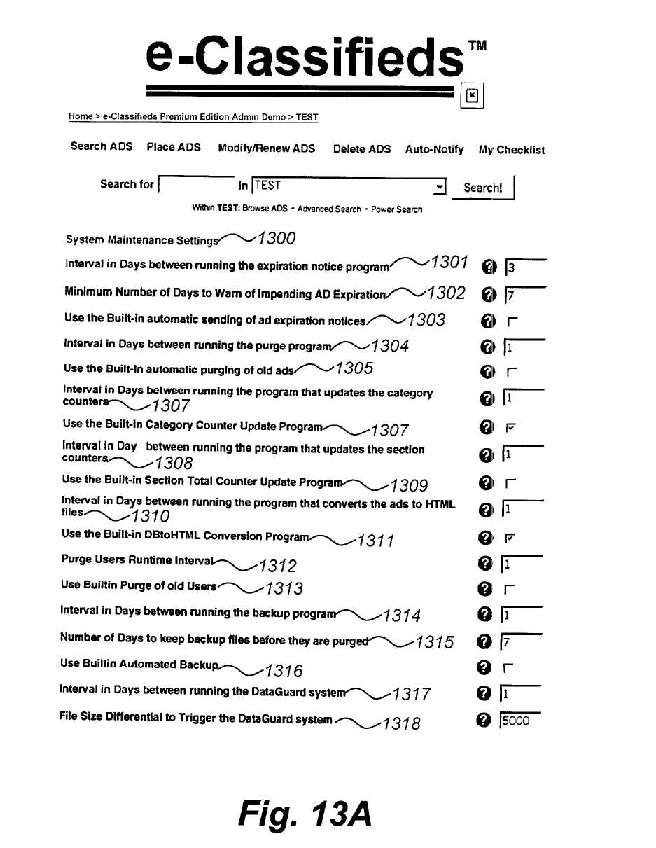

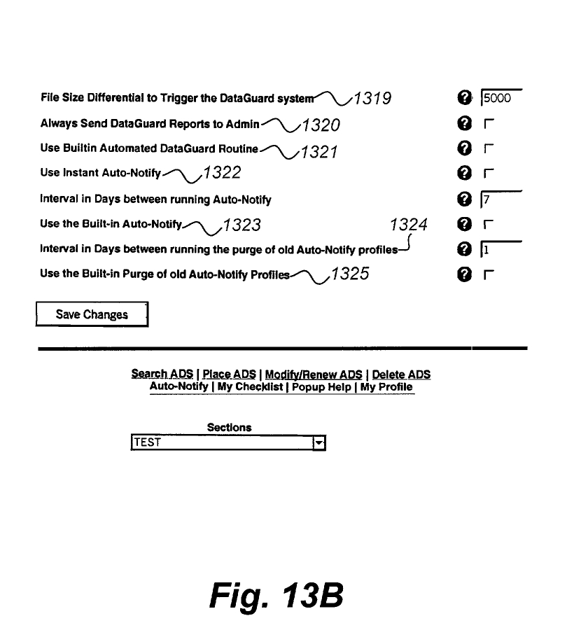

Referring to FIG. 13, these backup variables are explained in greater detail below:

Interval in Days between Running the Backup System (1314)

This variable specifies the minimum number of days in between each time that administrator wants to run the “backup” system that creates a backup of all of Administrator important data files. That way, it won't be run more often, causing unnecessary system overhead for The server. If the administrator is not sure how to set this, we suggest that administrator leaves it set equal to “1”.

Number of Days to Keep Backup Files before they are Purged (1315)

This variable specifies the number of days that the system will keep old backup files before they are automatically purged. If Administrator backup files are never purged, the amount of disk space that they take up could become quite large, since each system backup creates backup files for all of Ads databases, Auto-Notify profiles, and registered end users. Thus, it is very important to allow the system to periodically purge these files. On the other hand, they should be kept long enough so that administrator will have time to restore an older, clean backup if the administrator don't discover a data problem right away and some of the more recent backups are corrupted. A good default value might be 7 days.

Use Builtin Automated Backup (1316)

This box should be checked only if the administrator is not using the separate BACKUP.PL file and administrator wants the system to automatically back up Administrator important data files, which include the Ads databases, the Auto-Notify profiles, and user registration database.

Interval in Days between Running the DataGuard System (1317)

This variable specifies the minimum number of days in between each time that administrator wants to run the “DataGuard” system that checks all of Administrator important data files to see if they have unexpectedly shrunk in size, which could indicate that they have been corrupted or deleted. That way, it won't be run more often, causing unnecessary system overhead for The server. If the administrator is not sure how to set this variable, it is suggested that administrator leaves it set equal to “1”.

File Size Differential to Trigger the DataGuard System (1318)

This variable specifies the file size differential that will trigger the DataGuard system to display or e-mail a warning message to the admin. In other words, if the current data file is smaller than the last equivalent backup data file by this many bytes or more, the warning system will be triggered, which could alert administrator to potential corruption or deletion of an important data file. If the administrator is not sure how to set this variable, we suggest that administrator leaves it set equal to “5000”.

Always Send DataGuard Reports to Admin (1319)

This box should be checked only if the administrator wants the DataGuard system to always send e-mail reports to the administrator, even when it doesn't find any problems. If this box is not checked, the DataGuard system will send e-mail reports to the admin only when it detects potential problems with one or more of Administrator important data files.

Use Builtin Automated DataGuard Routine (1320)

This box should be checked only if the administrator is not using the separate DATAGUARD.PL file and administrator wants the system to automatically run the DataGuard routine that checks Administrator important data files to see if they have shrunk unexpectedly, which could indicate that they have been corrupted or deleted. These files include the Ads databases, the Auto-Notify profiles, and User Registration database.

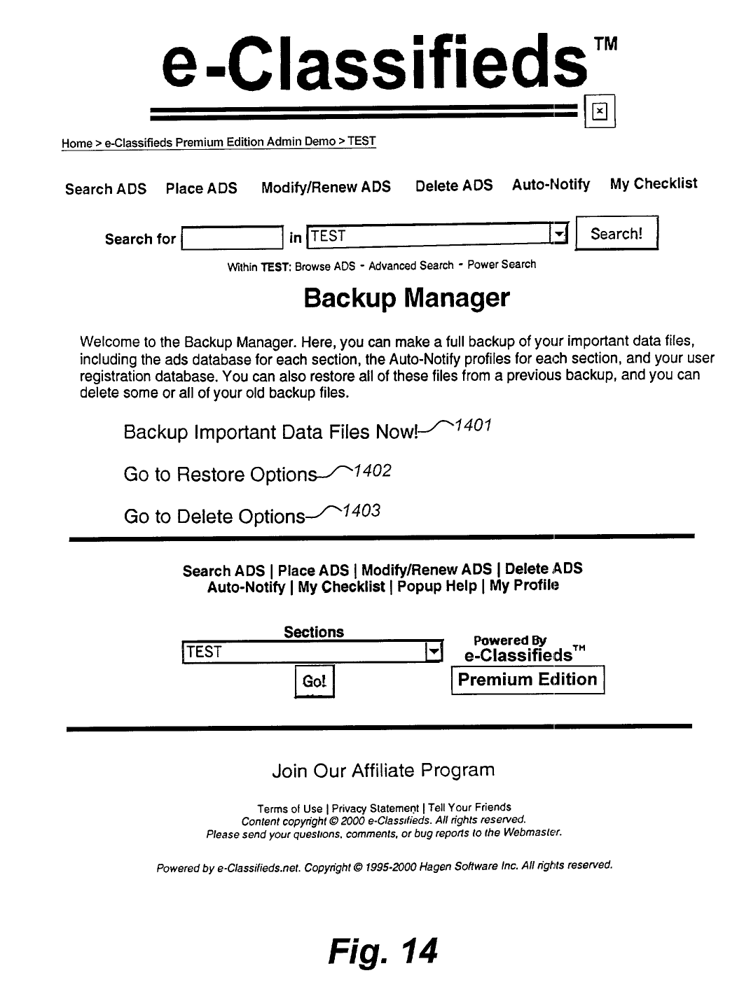

Referring to FIG. 14, the Backup Options section of the Control Panel (585) allows the administrator to backup Administrator important data files, restore from a previous backup, and run the DataGuard routine that will check Administrator current data files to see if they have been corrupted. The Admin is presented with three options using the Backup Manager (586):

Backup Important Data Files Now! (1401), Go to Restore Options (1402), Go to Delete Options (1403)

Clicking on Backup Important Data Files Now! (1401) causes the system to make a full backup of important data files, including the ad database for each section, the Auto-Notify profiles for each section, and User Registration database. The admin can restore all of these files from a previous backup, and the admin can delete some or all of old backup files.

Clicking on Go to Restore Options (1402), causes the current backups (if any) to be displayed based on the time that they were created. If the Administrator would like to restore important data files from one of these backups, please choose the radio button next to the backup group that Administrator would like to restore. This action will overwrite all of the data files including all of the Ad databases, all of the Auto-Notify profiles, and the entire end user registration database. If the admin wants to restore an individual file, rather than the entire backup set, click on the View All Individual Backup Files link to view all of the individual backup files.

Go to Delete Options (1403) will list current backups (if any) are based on the time that they were created. The Admin can delete one or more of these backups by checking the box next to each backup group that to be deleted. If the Admin wants to delete all backup files, click on the “Delete All Backups” link. Once these files are deleted, they cannot be recovered.

Referring back to FIG. 5, the DataGuard (587) option runs the DataGuard system, which will check all of Administrator important data files to see if they have unexpectedly shrunk in size, which could indicate that they have been corrupted or deleted. If there are no backups created, a message will appear stating that the DataGuard routine was not able to compare current data to backups because there are currently no backups

Referring back to FIG. 13, the Always Send DataGuard Reports to Admin (1319) box should be checked only if the Admin wants the DataGuard system to always send e-mail reports to him or her, even when it doesn't find any problems. If this box is not checked, the DataGuard system will send e-mail reports to the admin only when it detects potential problems with one or more important data files.

Use Builtin Automated DataGuard Routine (1320) box should be checked only if the admin is not using the separate DATAGUARD.PL file and he or she wants the script to automatically run the DataGuard routine that checks your important data files to see if they have shrunk unexpectedly, which could indicate that they have been corrupted or deleted. These files include the ads databases, the Auto-Notify profiles, and your user registration database.

Auto-Notify System allows the administrator to run the Auto Notify system that sends the Ads that match each end user's pre-defined.

Use Instant Auto-Notify (1321) variable determines whether the system will run the Auto-Notify system immediately after a new Ad is posted. The advantage of checking this box is that subscribers will be notified of new Ads matching their search criteria immediately. The disadvantage is that the Auto-Notify routines will run every time a new Ad is posted, which could start to use a lot of system resources if the system gets a lot of new Ads. In that case, administrator might want to leave this box unchecked and then run the Auto-Notify system at regular timed intervals using the variables below. If this box is checked, the regular version of Auto-Notify that runs at timed, periodic intervals and that is defined by the variables below will automatically be disabled by the system in order to prevent subscribers from receiving multiple notices for the same new Ad. Also, if the administrator is requiring administrative approval of new Ads and thus has set the Require Admin Approval variable equal to “on”, administrator should turn off the Use Instant Auto Notify variable, as there is no point in running it since it won't send Ads that have not yet been approved out to subscribers. Also, if the administrator uses Instant Auto-Notify, the options for being notified only of Ads with photos, sound clips, or video clips will be disabled, since these are not actually included in the Ad until after it has been posted, and after the Instant Auto-Notify engine would run.

Interval in Days between Running Auto-Notify (1322)

This variable specifies the number of days in between each time that administrator wants to run the Auto-Notify system. That way, it won't be run more often, causing Users to receive multiple, annoying e-mail messages. If the administrator wants to run Auto-Notify once a week, for example, administrator would set this variable equal to “7”, for a 7 day interval. This also specifies the number of days back that Ads will be included in the periodic notices. In other words, if the administrator set this equal to “7”, then the search agent will retrieve only those Ads that match the user's search criteria and that were posted within the past 7 days.

Use the Built-in Auto-Notify (1323)

Check this box if the administrator wants the system to automatically use its built-in Auto-Notify feature. If the administrator has access to “cron jobs” or some other process that can automatically run the separate autonotify.pl files, administrator should leave this box unchecked.

Interval in Days between Running the Purge of Old Auto-Notify Profiles (1324)

This variable specifies the minimum number of days in between each time that administrator wants to run the “autonotify purge” system that purges all autonotify profiles that have expired. That way, it won't be run more often, causing unnecessary system overhead for The server. If the administrator not sure how to set this, we suggest that administrator leaves it set equal to “1”.

Use the Built-in Purge of old Auto-Notify Profiles (1325)

Check this box if the administrator wants the system to automatically use its built-in purging of old Auto-Notify profiles. If the administrator has access to “cron jobs” or some other process that can automatically run the separate autonotify_purge.pl files, administrator should leave this box unchecked.

Referring to FIG. 5, the Auto-Notify Maintenance Section of the Control Panel (570), Run Auto Notify System (571) option allows the administrator to run the Auto Notify system, which will cause the system to perform a search for each end user who has signed up for the Auto Notify feature and e-mail that person with a message containing a short description of all Ads matching her or her search criteria that have been posted in the past 7 days. The message will contain links to the full Ads in the database.

Purge Old Auto Notify Profiles (572) option allows the administrator to purge all Auto Notify profiles that have expired.

Edit End Users' Auto-Notify Profiles (573) option allows the administrator to modify or delete the Auto-Notify profiles that users have set up on the system. Administrator might want to do this if the administrator is receiving bounced mail back from an e-mail address that a user specified when setting up their profile, but that is no longer valid. Each Auto-Notify message that is sent out contains the ID number for that profile, as well as the section that it was created in, so administrator can enter this profile ID number in the form that administrator will see after he or she clicks on the “Modify” or “Delete” button. The administrator can modify or delete any user's profile.

Delete All Auto-Notify Profiles (574) option allows the administrator to delete all Auto-Notify profiles for the Particular section.

As illustrated in FIG. 5, the Template Editor (511) allows the Administrator to modify the HTML for the general page layout of all pages generated by the system. The Template Editor also allows the administrator to create customized page displays for each of the top-level sections, as well as for each affiliate web site (and even for each section within each affiliate web site). There are several pre-defined templates to choose from, or an administrator can create their own either by entering the raw HTML code or importing it from a file created by another HTML editor such as Dreamweaver or Frontpage, etc. It is also possible to modify the HTML and system code contained in the “Objects” used in the Template Editor. Administrator can also move “objects” for various items such as advertising banners, the navigation bar, and more around the page. Other template driven systems are typically more restrictive in allowing these type of changes.

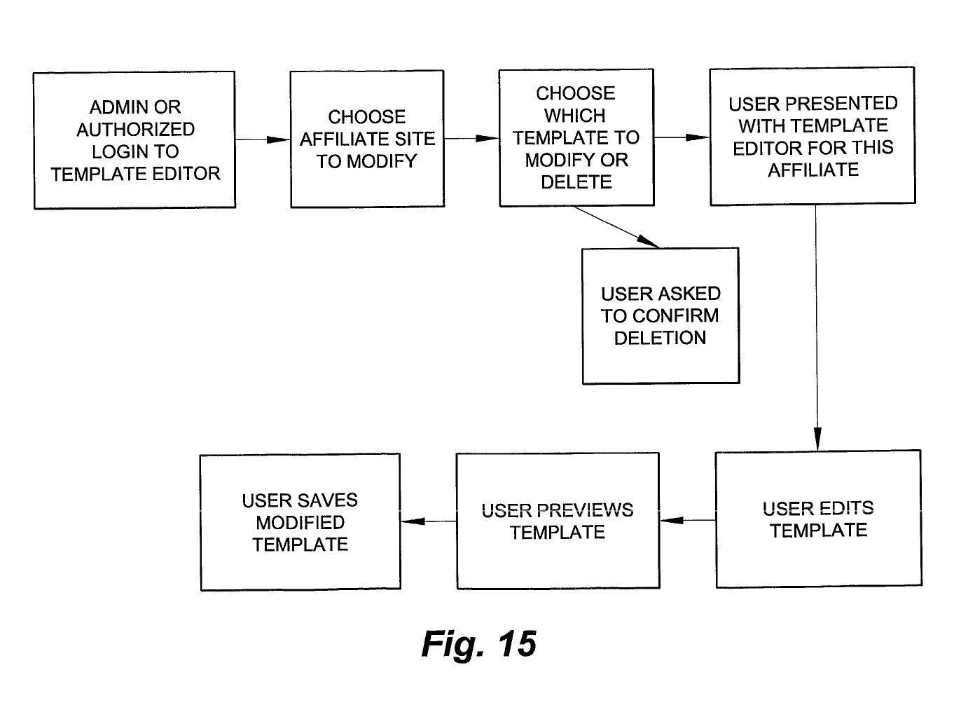

As illustrated briefly in FIG. 15, if you want to modify the page layout for a particular section, choose the appropriate section. For the default template, if a template already exists for that section, you will have the option of editing or deleting that template via the “Edit” and “Delete” buttons. If a template does not currently exist for that section, these buttons will not be displayed, and a “Create” button will be displayed instead.

If the Administrator chooses to modify the default template for the default affiliate, which is your flagship site, the template presented has special meaning, since it will be used for all of sections that do not have their own templates, as well as for all other affiliates that do not specify their own templates. In other words, the template that are created will be the ultimate “fallback” template that is used whenever a particular section and/or affiliate does not have a template of its own.

Select a template from the template options on the left hand side of the form. Initially, your current template (if any) is automatically entered into the form below. You can always start with a new template again by selecting “Current”. Select “Blank” to clear the form below. To preview the other templates, for each one, select it and then click on the “Preview” button below.

Use the options on the left hand side of the form that is created to add Objects or various HTML tags to the template. If you have created a template offline in an HTML editor such as Frontpage or Dreamweaver, you can copy and paste the code from that page into the form below using the appropriate commands for your computer (for example, Windows users should click at the spot in the form below where you want to insert the copied text and then simultaneously press the Control and the V keys to paste text from the clipboard into the form below).

Preview your work at any time by clicking on the “Preview Template”. When you are satisfied with your template, click on the “Save Template” button below. This process can be repeated for new templates.

As illustrated in FIG. 5, this Set Visibility Options option (512) allows the administrator via the Control Panel to define the Visibility options, if any, that will be available to Ad posters who wish to pay an extra fee to raise the visibility of their Ad. These options might include displaying the Ad in bold text, in red text, with an extra graphic, or in some other manner.

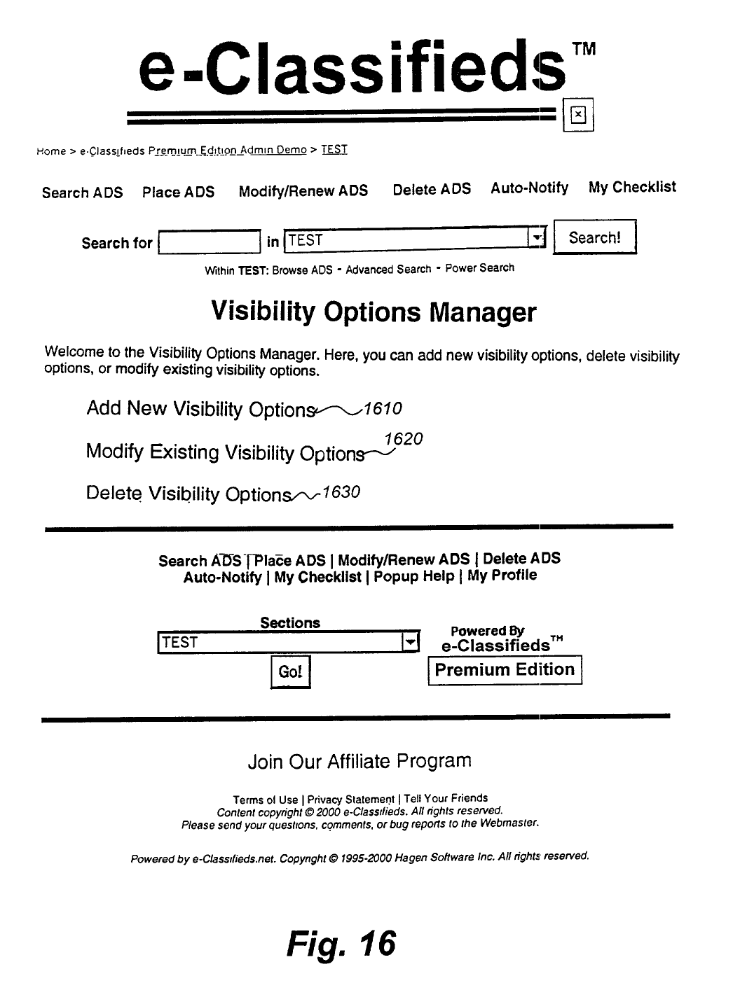

As illustrated in FIG. 16a, the administrator chooses through the Visibility Options Manager 1600 whether he or she wants to Add New (1610), modify existing (1620) or Delete Existing (1630) Visibility Options.

In Add New Visibility Options, the Administrator is asked how many visibility options are to be created (1611). After submitting the number to be created, existing visibility options are displayed in the initial rows (1612). Beneath these rows, in the rows with a background color, one row has been created for each new visibility option that has been requested. For each of these rows, there are six fields to fill in (1613).

Key # (1614) refers to the unique key number that will identify this option. Users will be presented with these options in numerical order based on this key number, from lowest to highest, so the lowest key number should refer to the least expensive option (normally 0, for normal visibility), with the key numbers rising for successively more expensive options. In order to allow room for adding options with prices in between the existing options, we recommend using intervals of 10 for these key numbers. On the other hand, we don't recommend using larger key numbers, since this will needlessly waste extra space in the databases. This field is mandatory.

Description (1615) refers to the short description of this option that end users will see when these options are listed. This field is mandatory.

Price (1616) refers to the cost to the user of selecting this visibility option. Do NOT use any currency values here. All values should be numeric values only. This field is mandatory.

Opening HTML Tag (1617) refers to the opening HTML tag that will encapsulate the listings that have purchased this option. An example would be the <b> tag for an option that would cause the end user's ad to be bolded. This field is optional (if Administrator don't enter anything here or in the Closing HTML Tag field, ads using this option will appear as normal ads).

Closing HTML Tag (1618) refers to the closing HTML tag that will encapsulate the listings that have purchased this option. An example would be the </b> tag for an option that would cause the end user's ad to be bolded. This field is optional (if Administrator does not enter anything here or in the Opening HTML Tag field, ads using this option will appear as normal ads).

Active? (1619) refers to whether Administrator wants this visibility option to be offered to end users. If Administrator check this box, once this new visibility option has been created, it will immediately become active and offered to Users. If Administrator would rather have it be inactive until Administrator can modify other aspects of visibility options settings, then Administrator should leave this box unchecked.

In the Modify Visibility Options (1620), the Admin will be presented with rows in tabular form which correspond to one of the existing visibility options. (1621) For each of these rows, there are the same six fields (1614-1619) to fill in as in Add New Visibility Options. Administrator current settings for each visibility option are already filled into these fields, so Administrator only need to modify the specific settings that Administrator wants to change here.

In the Delete Visibility Options (1630), the Admin will have the option to check the box next to each of the visibility options below that are to be permanently remove from the system (1631), and then click on the Verify Visibility Options to Remove button (1633) below. Removing these visibility options will cause all ads where the end user had purchased these options to no longer be displayed in this manner. In other words, these ads will now be displayed as normal ads. The Admin will see a confirmation page before these visibility options are permanently removed (1634).

As illustrated in FIG. 5, the Set Priority Ranking Options of the Control Panel (513) allows the administrator to define the Priority Ranking options, if any, that will be available to Ad posters who wish to pay an extra fee to cause their Ad to be displayed higher up in the search results. The Administrator can set multiple tiers and pricing levels if desired.

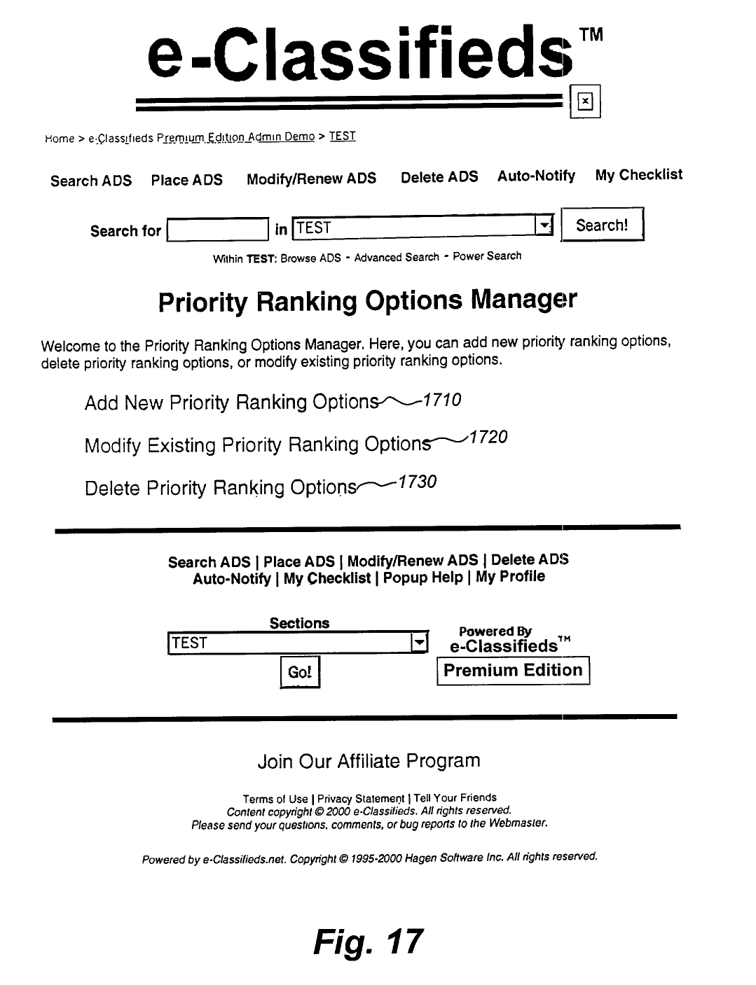

As illustrated in FIG. 17a, the Admin can add new priority ranking options (1710), delete priority ranking options (1720), or modify existing priority ranking options (1730).

In Add New Priority Ranking Options (1710), the Administrator is asked how many Priority Ranking options are to be created (1711). After submitting the number to be created, existing Priority Ranking options are displayed in the initial rows (1712). Beneath these rows, in the rows with a background color, one row has been created for each new Priority Ranking option that has been requested. For each of these rows, there are four fields to fill in (1713).

Key # (1714) refers to the unique key number that will identify this option. End users will be presented with these options in numerical order based on this key number, from lowest to highest, so the lowest key number should refer to the least expensive option (normally 0, for no priority), with the key numbers rising for successively more expensive options. In order to allow room for adding options with prices in between the existing options, we recommend using intervals of 10 for these key numbers. On the other hand, we don't recommend using larger key numbers, since this will needlessly waste extra space in the databases. This field is mandatory and should not be modified.

Description (1715) refers to the short description of this option that end users will see when these options are listed. This field is mandatory.

Price (1716) refers to the cost to the end user of selecting this priority ranking option. Do NOT use any currency values here. All values should be numeric values only. This field is mandatory.

Active? (1717) refers to whether Administrator wants this priority ranking option to be offered to end users. If Administrator check this box, this priority ranking option will immediately become active and offered to end users. If Administrator wants it to be inactive, then Administrator should leave this box unchecked. Inactive options will not be offered to end users, but ads in the databases that have purchased these options will continue to receive priority in the search results in the manner prescribed by these options. If Administrator plans to remove an option, and if Administrator has active database ads that have purchased this option, Administrator should deactivate it first, and then remove it later on, once all of the ads that were using this option have been purged or deleted. That way, Administrator can gradually phase out this option, while allowing end users who have already paid for it to continue to get what they paid for.

In Modify Priority Ranking Options (1720), the Admin is presented with rows in tabular form which correspond to one of the existing priority ranking options. For each of these rows, there are the same four fields (174-1717) to fill in as in Add New Priority Ranking Options. Administrator current settings for each priority ranking option are already filled into these fields, so Administrator only need to modify the specific settings that Administrator wants to change here.

In Delete Priority Ranking Options (1730), the Admin will have the option to check the box next to each of the priority ranking options below that are to be permanently remove from the system (1731), and then click on the Verify Priority ranking Options to Remove button (1732). Removing these priority ranking options will cause all ads where the end user had purchased these options to no longer be displayed in this manner. In other words, these ads will now be displayed as normal ads. The Admin will see a confirmation page (1733) before these priority ranking options are permanently removed.

As illustrated in FIG. 5, the Sections Manager section of the Control Panel (575) allows the administrator to create new sections (576) in addition to the default sections that come with the system or modify (577) or delete existing sections (578). After making a selections, online wizards help to complete these actions.

Creating New Sections (576) is a powerful option that allows the administrator to create new top-level sections. These sections allow for the creation of new databases instantly. The Administrator will be guided through this process by an intuitive online wizard.

First, a page asking how many sections are to be created. One table is created for each new section that Administrator has requested. Each of these tables corresponds to a section. For each table, there are the following five fields to fill in.

Short Name refers to the short, one word filename that will be used internally by the program to name all files associated with this section. It should be one word only, with no spaces. It should consist of only letters, numbers, or the _symbol, with no other punctuation marks. Preferably, it should use all lower case letters. This field is mandatory.

Long Name refers to the full name of this section that will be displayed in references to this section. This field is mandatory.

Description refers to the description that will be listed next to the link for this section on the front page of the web site. This field is optional.

Active? refers to whether the admin wants this section to be activated immediately. If Administrator check this box, once this section has been created, it will immediately become active and visible to Users. If the administrator would rather have the section inactive until Administrator can modify the database format or make other tweaks to this section, then Administrator should leave this box unchecked. In most cases, it is probably best not to activate the new section immediately upon creation, as Administrator may want to change some variables in the new *.db file for the new section, such as the categories in this section.

Icon Graphic refers to the name of the icon file that will displayed for this section on the front page and on other pages where all of the sections are displayed. This file must be stored in the “graphics” directory with the other graphics for the program. Administrator should list only the short file name here, and not the full URL.

Section to copy refers to the existing section whose database format should be copied and used by this new section. This field is mandatory.

If mandatory fields are not filled in, a Error page is created that states “We're sorry, but you did not fill in either the Short Name and/or Long Name fields for one or more of the sections that you are creating or modifying. Please go back and make sure that you have filled in these fields for all of the sections that you wishes to create or modify”.

If all of the mandatory fields are filled in, the program successfully creates the new sections that Administrator specified. For example, if the Administrator created a new section abc, the new sections that Administrator created would be outlined in the table:

| Short | Long | | Based | Icon | |
|---|---|---|---|---|---|
| Name | Name | Description | Upon | Graphic | Active? |
| abc | abcdef | | xyz | | yes |

Each section has one database definition file (abc.db) that defines the database fields (including the categories) for that section and one configuration file (abc.cfg) (plus a backup copy—abc.cfg.bak) that defines other parameters for that section. For example, these files are stored in the “db” directory located in the following location on the computer web server:

/usr/www/users/username/cgi-bin/ads/db

The Administrator may want to modify the general configuration settings for one or more of these new sections. To do so, click on follow the link below:

Modify Configuration Variables for a specific section

A Choose Section to Modify page will appear

The Administrator would check the radio button next to the top-level section below that is to be modified, and then click on the Display Modification Form button below. Administrator will see a page that will contain a modification form for the section that is selected. This form will be filled in with the current attributes for that section and will allow the changing of the attributes of that section.

The variables presented for modification by the Administrator are the following:

Override Global Fee Settings

This box should be checked if Administrator wishes to override the global fee settings with settings specific to this section. Administrator can specify different ad durations and prices for posting ads in this section, as well as whether to charge for renewing ads in this section and the amounts of those charges. These are determined by Administrator settings for the Ad Duration Choices, Charge for Posting, First Tier of Ads, Charge for First Tier of Ads, Charge for each Additional Ad, Charge for Renewing Ads, and Amount of Charge for Renewing Ads variables. If this box is not checked, then the global fee-based settings will apply in this section.

Ad Duration Choices

This “array variable” should contain the choices for end users as to how many days their ad will remain posted before it expires and is purged. If Administrator only want to give them one choice, then just include one value in this array. Each value should be listed on a separate line.

Charge for Posting

This box should be checked if Administrator wishes to operate a fee-based system that requires end users to pay for posting new ads. If Administrator does not wish to charge end users for posting new ads, then leave this box unchecked.

First Tier of Ads

This variable specifies how many ads an end user must place before receiving the rates specified below in the Charge for Each Additional Item variable. Until they post the number of ads that Administrator specifies here, they will be charged at the rates that Administrator define below in the Charge for First Tier of Items variable.

Charge for First Tier of Ads

This “array variable” should contain the fees for the first group of ads posted by a registered end user. The number of items in this array should be exactly the same as the number of items in the Ad Duration Choices array above. The first item in the array below will be the cost for the first group of ads posted by an end user for the duration contained in the first item in the Record Duration Choices array above. For example, if the first item in that array is 30 (ad displayed for 30 days), then the first item here should be the charge for ads posted for 30 days. This will only be charged if Administrator turned on the Charge for Posting variable. Do NOT include dollar signs or any other currency symbol in front of these values, which should be numeric values only. Each value should be listed on a separate line.

Charge for each Additional Ad

This “array variable” should contain the fees for ads posted by a registered end user who has already posted a number of ads equal to the number that Administrator set above in the First Tier of Ads variable. The number of items in this array should be exactly the same as the number of items in the Ad Duration Choices and First Ad Cost arrays above. The first item in the array below will be the cost for an ad posted by an end user (who has already passed the first tier pricing level) for the duration contained in the first item in the Ad Duration Choices array above. For example, if the first item in that array is 30 (ad displayed for 30 days), then the first item here should be the charge for ads posted for 30 days. This will only be charged if Administrator has turned on the Charge for Posting variable. Do NOT include dollar signs or any other currency symbol in front of these values, which should be numeric values only. Each value should be listed on a separate line.

Charge for Renewing Ads

This variable specifies whether or not the program will charge end users who renew their ads. To enable charging for renewals, check this box. Otherwise, leave this box unchecked.

Amount of Charge for Renewing Ads

If Administrator has enabled charging for renewals by checking the Charge for Renewing box, this variable specifies the amount of the charge. Do NOT include dollar signs or any other currency symbol in front of this value, which should be a numeric value only.

The Administrator can set the configuration variables in each section to use the Intellisplay or Auto-Generate or Customized options for the Post Ad, Preview Ad, Advanced Search, Headlines Display, and Full Size Display pages for each section. Doing so will cause the program to produce nice looking forms for these functions that will adjust automatically to database field changes, without requiring the Administrator to manually edit any files.

However, if Administrator wants to create customized forms for a particular section, this is also possible. To manually create customized forms, Administrator would first edit the configuration variables for that section by setting one or more forms to the Custom setting. Administrator would then need to edit or create the customized forms. If these files already existed for the section whose format was being copied, then these files were copied and new files were created for the new section. Even if they did not exist for the old section, Administrator can still create customized files for these displays in the new section. These files must be stored in the subdirectories for the languages that Administrator has installed. Based on the current language that Administrator are using, these files (if they existed before) have been created in the following location on The server:

/usr/wwwlend users/monal/beautycare/cgi-bin/ads/language/english/sections

The following files would correspond to the new sections that Administrator created:

For the xyz section:

xyz.power_search.pl

xyz.headlines_display.pl

xyz.long_display.pl

xyz.post_item.pl

xyz.preview_item.pl

If the administrator is using custom page displays for the ad posting, ad preview, advanced search, headlines display, and/or full size display pages, any changes that administrator make to the database structure in the *.db files will NOT automatically change those pages. Administrator will need to either edit the HTML in those pages to match the new fields or other changes that administrator has made in the database structure, or switch from using the “custom” pages to using the auto-generated pages (either in generic format or the “intellisplay” mode).

“Post Item” Form Type

This variable specifies whether the program will use an enhanced auto-generated display (the “Intellisplay” option), a basic auto-generated display (“Auto-Generate”), or a customized form that Administrator has created for the “Post Item” form (“Use Custom Form”). Usage of the “Intellisplay” option is recommended, as this requires no coding, is very flexible in that it will automatically adjust the forms if the database fields are modified, and creates nice looking forms. The “Use Custom Form” option should not be selected unless there is a specific need for a customized form, and a customized “Post Item” form and file for this section has been created.

“Preview Item” Form Type

This variable specifies whether the program will use an enhanced auto-generated display (the “Intellisplay” option), a basic auto-generated display (“Auto-Generate”), or a customized display that Administrator has created for the “Preview Item” display of the ads that end users see before actually posting their ads (“Use Custom Form”). Usage of the “Intellisplay” option is recommended, as this requires no coding, is very flexible in that it will automatically adjust the forms if the database fields are modified, and creates nice looking forms. The “Use Custom Form” option should not be selected unless there is a specific need for a customized form, and a customized “Post Item” form and file for this section has been created.

“Power Search” Form Type

This variable specifies whether the program will use an enhanced auto-generated display (the “Intellisplay” option), a basic auto-generated display (“Auto-Generate”), or a customized form that Administrator has created for the “Power Search” form (“Use Custom Form”). Usage of the “Intellisplay” option is recommended, as this requires no coding, is very flexible in that it will automatically adjust the forms if the database fields are modified, and creates nice looking forms. The “Use Custom Form” option should not be selected unless there is a specific need for a customized form, and a customized “Post Item” form and file for this section has been created.

“Headlines” Display Type

This variable specifies whether the program will use an enhanced auto-generated display (the “Intellisplay” option) or a customized display that Administrator has created for the “headlines” display of the ads (“Use Custom Form”). Usage of the “Intellisplay” option is recommended, as this requires no coding, is very flexible in that it will automatically adjust the forms if the database fields are modified, and creates nice looking forms. The “Use Custom Form” option should not be selected unless there is a specific need for a customized form, and a customized “Post Item” form and file for this section has been created.

Full Size Ads Display Type

This variable specifies whether the program will use an enhanced auto-generated display (the “Intellisplay” option), a basic auto-generated display (“Auto-Generate”), or a customized display that Administrator has created for the full size display of the ads (“Use Custom Form”). Usage of the “Intellisplay” option is recommended, as this requires no coding, is very flexible in that it will automatically adjust the forms if the database fields are modified, and creates nice looking forms. The “Use Custom Form” option should not be selected unless there is a specific need for a customized form, and a customized “Post Item” form and file for this section has been created.

“Features” Label

This variable specifies the header that the program will use for the section that contains the general features of the item being listed. If the Administrator has not set any of the database fields to “features”, this header will not be displayed.

“Options” Label

This variable specifies the header that the program will use for the section that contains the specific options or amenities of the item being listed. This will be a section that contains checkmarks next to each option or amenity that this item has. If the Administrator has not set any of the database fields to “features”, this header will not be displayed.

“Contact Info” Label

This variable specifies the header that the program will use for the section that contains the seller's or poster's contact information.

“Search Options” Label

This variable specifies the header that the program will use for the database search fields section of the Power Search form.

Display Popup Car Payments Calculator

This variable specifies whether the program will display an icon for the popup car loan payments calculator in ads posted in this section. This generally would be applicable only to an automobiles section.

Display Popup Mortgage Calculator

This variable specifies whether the program will display an icon for the popup mortgage calculator in ads posted in this section. This generally would be applicable only to a real estate or related section.

Display Map Link Button

This variable specifies whether the program will display an icon that links to an outside map of directions to the address listed in the ad. This generally would be applicable only to a real estate or related section.

Default Map Country

This variable specifies the default country that should be used for the feature that links to maps from the ads. If no country is listed, the program will automatically assume that the address specified in the ad is located in this country. The only valid choices here are “USA”, “Canada”, or “None”.

Title for Static HTML Pages

This variable specifies the text that will go in the Title tag of the static HTML pages for ads in this section that are created if or when the DBtoHTML function is run.

Keywords for Static HTML Pages

This variable specifies the keywords that will go in the Meta tags of the static HTML pages for ads in this section that are created if or when the DBtoHTML function is run.

Default Interest Rate

This variable specifies the default interest rate that will be listed in the popup loan calculator and popup mortgage calculator.

Default Number of Loan Months

This variable specifies the default number of months for the duration of the loan that will be listed in the popup loan calculator.

Default Number of Mortgage Years

This variable specifies the default number of years for the duration of the mortgage that will be listed in the popup mortgage calculator.

Default Yearly Property Tax

This variable specifies the default amount of the yearly property tax that will be listed in the popup mortgage calculator.

Default Yearly Property Insurance Payment

This variable specifies the default amount of the yearly property insurance that will be listed in the popup mortgage calculator.

By clicking on Save Changes, a page appears stating that the “Section Variables Successfully Updated. The program has successfully updated the General Variables for the particular section”.

Modifying Sections

This option allows the administrator to modify the sections. The Administrator has two choices: he can modify the overall “global” settings for all of the sections, such as the short and long names for the sections and the icon graphic to display next to each section on the front page. Administrator can also modify the settings for a specific section, such as whether to set specific fee options for a particular section, whether to display certain items such as maps or popup calculators in that section, and which types of forms and displays to use within that section.

Modify Global Sections Options

The Administrator will check the box next to each top-level sections below that is to be modified, and then click on the Display Modification Form button. The Administrator will see a page that will contain a modification form for each section that Administrator select here. For each section, this form will be filled in with the current attributes for that section and will allow Administrator to change the attributes of that section.

Modify Configuration Variables for a Specific Section

The Administrator will check the radio button next to the top-level section below that is to be modified, and then click on the Display Modification Form button below. The Administrator will see a page that will contain a modification form for the section that Administrator select here. This form will be filled in with the current attributes for that section and will allow Administrator to change the attributes of that section.

Deleting Sections

This option allows the administrator to delete top-level sections from the system. The Administrator will be asked to verify selections before any sections are actually deleted.

Check the box next to each of the top-level sections below that are to be permanently removed from the system, and then click on the Verify Sections to Remove button below. Removing these sections will remove all of their associated data files, database definition files, and customized forms and displays (if any have been created). A confirmation page will appear before these sections are permanently removed.

After removal, a page stating “The program has successfully removed the sections that you specified for permanent removal (listed by their short name)

All of the associated data files, database definition files, and customized forms and displays (if any were created) for each of these sections are also permanently deleted. The Administrator is then presented with a link to the Control Panel in order to avoid any errors that might result from attempting to load pages from sections that have been deleted.”

Modifying the Database Fields Within a Section

Within each section, administrator can modify the database fields by editing the %dbfields variable (technically, it's called an “associative array” or a “hash”) at the beginning of the *.db file for that section (the *.db files are contained in the “db” subdirectory). Within the %dbfields variable, the numbers along the left hand correspond to the key number for each field in The database. The values to the right of each key (contained within the [ ] brackets to the right of the => symbol) correspond to the database settings for this field. Within these brackets, there are 21 settings. Each of these settings is contained within the ”, separated by a comma. These settings are described below:

The first eleven fields (with key numbers 0-10) are special fields that are used by the system to keep track of certain housekeeping information about each ad or record, such as its unique ID number within the database, who posted it, the date that it was posted, and other important pieces of information.

Field 1=> This is the short name for this particular database field, such as “category” or “email”. This must be one word, with no spaces or punctuation, using only letters or numbers.

Field 2=> This determines whether the default sorting method for this field is ascending or descending. It must be set to “ascend” or “descend”.

Field 3=> This determines whether this field will be displayed on the ad posting form. Administrator can specify the order in which The database fields will appear on the ad posting form by putting numbers into this field. The fields with the lowest numbers will be displayed first, at the top of the ad posting form. Otherwise, just enter “on” into this field.

Field 4=> This determines whether this field will be displayed on the Advanced Search form. Administrator can specify the order in which The database fields will appear on the Advanced Search form by putting numbers into this field. The fields with the lowest numbers will be displayed first, at the top of the Advanced Search form. Otherwise, just enter “on” into this field.

Field 5=> This determines whether this field will be displayed when ads are displayed in the “headlines” format. Administrator can specify the order in which The database fields will appear on the headlines display by putting numbers into this field. The fields with the lowest numbers will be displayed first, on the left hand side of the headlines display. Otherwise, just enter “on” into this field.

Field 6=> This determines whether this field will be displayed in the full size ads. Administrator can specify the order in which The database fields will appear on the full size ads by putting numbers into this field. The fields with the lowest numbers will be displayed first, at the top of the ad. Otherwise, just enter “on” into this field.

Field 7=> This is the long name for this field, such as “E-Mail Address”. If Field 12 below has been set to “<>”, then this field should contain three values, separated by the pipe symbol (the | symbol). The first value will be the regular name of this field, the second value will be the “low” value (such as “Lowest Price” for a price field), and the third value will be the “high” value (such as “Highest Price” for a price field).

Field 8=> This determines whether the end user will be able to submit multiple values for this field when conducting searches.

Field 9=> This determines whether this is a required field that must be filled in when end users post ads.

Field 10=> This determines whether the system will limit the text in this field to the number of words that administrator specified in the Maximum Words variable in the System Configuration utility. Generally, administrator would use this only for large textarea boxes, such as the body of the ad.

Field 11=> This is the data type for this field. Valid values include “string” (for regular text), “number” (for numbers), or “date” (for dates in the MM/DD/YY or MM/DD/YYYY format).

Field 12=> This is the comparison operator that will be used when the system is searching this field in the database. Valid values include “=” (for “string” data types, such as text) and “<>” (for “number” data types, such as numbers, and also for dates in some situations).

Field 13=> This determines whether this field will be among the fields that are searched when end users conduct a general Keyword Search.

Field 14=> This specifies the HTML form input type that will be used for this database field on the various forms, such as the ad posting, advanced search, and other forms. Valid values include “text”, “textarea”, “radio”, “select”, and “checkbox”.

Field 15=> This setting is relevant only if the HTML form input type has been set to “text” (in which case it determines the length of the text input field), or “textarea” (in which case it determines the number of rows in the textarea box).

Field 16=> This setting is relevant only if the HTML form input type has been set to “text” (in which case it determines the maximum number of characters that end users may enter in the text input field) or “textarea” (in which case it determines the number of columns in the textarea box).

Field 17=> This setting is relevant only if the HTML form input type has been set to “select” or “radio”, in which case this setting should contain all of the default values that will be listed in the dropdown select box or the radio buttons. Each value should be separated by the pipe symbol (the symbol).

Field 18=> This setting should be set to “on” if the administrator wants this field to be an Auto-Notify field, meaning that end users will be able to define search values for this field when setting up an Auto-Notify agent.

Field 19=> This setting determines the display type. This is how this particular field will be displayed on the ad displays and the ad posting form. Valid values include “regular”, “bold”, “e-mail-primary” (this is for the main “email” field, which administrator should not remove in most situations), “email-secondary” (this is for any additional e-mail fields that administrator add to the database), “url”, “optional”, and “wide” (this will take up more column rows in ad displays).

Field 20=> This setting determines the display category for this particular field in the ad displays. Valid values include “general” (for general information), “description” (for the body of the ad; by default, this is the “text” field), “contact” (for contact information such as the name, address, telephone number, etc.), “features” (for general features that might be displayed in the same area of the ad, such as body type, transmission, etc. in an autos section), and “options” (for options that will be displayed together in the same area of the ad as checkboxes (for “yes” or “no” fields, such as AC, Defroster, Leather Seats, etc., in an autos section).

Field 21=> This setting determines the maximum number of characters that end users will be able to enter into the database for this field. That way, even if they download and edit the HTML for the ad posting page in an attempt to circumvent Administrator “maxlength” settings, the system will strip out all characters that exceed the limit that administrator set here.

Modifying the Subcategories Within a Section

As an example of modifying database fields within Sections, The Administrator can modify the subcategories within a section (the categories that are listed on the front page of that section when user first enters it) by modifying one variable in the “.db” file for that particular section. These “.db” files are contained in the “db” subdirectory, and each one corresponds to a particular section. For example, the autos.db file corresponds to the Automobiles section, the employment.db file to the Employment section, and so forth. To modify the categories within a particular section, we recommend that administrator first make a backup copy of the working “.db” file for that section. Then, open up the “.db” file for that section in a text editor such as Notepad and look for the field named “category” in the %dbfields variable at the beginning of that file. The 17th field within that variable contains the actual categories. Administrator can change these to whatever administrator wants, as long as administrator maintain the proper syntax by separating each category with the pipe symbol (the “|” symbol). Once administrator is done editing categories, save the file in plain ASCII text format. Upload the file back to the server, overwriting the existing “.db” file. This section will now display Administrator newly modified categories.

As illustrated in FIG. 5, the Ads Maintenance section of the Control Panel (550) provides a number of options relating to the Ads posted by end users on the system.

The administrator can modify or delete any Ad posted by any end user by clicking on the Modify User Ads (552) or Delete Ads (553) links. If the administrator has set Ad moderation on, administrator can also preview new Ads that have been posted by clicking on the Preview New Ads link (551). Administrator can modify the multimedia files that end users have uploaded to their Ads by clicking on the Edit Multimedia Files in User Ads link (554). To send out expiration notices to end users whose Ads are about to expire, click on the Send Out Expiration Notices link (555). Administrator can purge old Ads via the Purge Old Ads option. If the administrator wants to delete all Ads on The system, administrator can do so by clicking on the Delete All Ads (557) link. Administrator can also update the counters for both the total number of Ads in this section (558), as well as in each subcategory (559). Administrator can view (560) or clear the logs (561) created by the system when Ads are posted, modified, or deleted, and the administrator can create HTML pages for all Ads in the system (562).

Previewing New Ads (551)

This option allows the administrator to preview all new Ads that have been posted since the administrator last ran the preview system.

By then clicking on the “Preview New Ads” (551) link, the Administrator will see a page displaying all of the new ads in this section that are awaiting approval. For each ad, administrator will have the option of approving, modifying, or deleting the ad, as well as viewing it. Administrator can always defer action on a particular ad simply by taking no action for that ad. If the administrator takes no action on an ad, it will remain in the “temporary” status, will not be viewable by end users, and will be displayed again the next time that administrator enter this special administrative approval mode.

Modifying User Ads (552)

This option allows the administrator to modify any Ad posted by any end user. In the Modify Administrator Ad form, enter the Ad Number of the Ad that administrator wants to modify. The Ad and a modification form will then be displayed for administrator.

Deleting User Ads (553)

This option allows the administrator to delete any Ad posted by any end user. In the Delete Administrator Ad form, enter the Ad Number of the Ad that administrator wants to delete. The Ad will be displayed along with a warning notice asking administrator if the administrator is sure that administrator wants to delete this Ad. If so, click on the Delete button to delete the Ad.

Editing Multimedia Files in User Ads (554)

This option allows the administrator to upload a new multimedia file to any end user's Ad or to delete any of the existing multimedia files for that Ad. In the Upload A Multimedia File form, enter the Ad Number of the Ad that administrator wants to add the multimedia file to. Then administrator will need to click on the Browse button and select a file from Administrator local computer to upload for inclusion in this end user's Ad.

Sending Out Expiration Notices (555)

This option allows the administrator to send out expiration notices to all end users who have posted Ads that are about to expire.

Purging Old Ads (556)

This option allows the administrator to purge all Ads that have expired

Deleting All Ads (557)

This option allows the administrator to delete all Ads. The administrator should want to do this before running this system, because he or she may not be able to recover the deleted Ads.

Update Category Counters (558)

This option allows the administrator to run the Catcount system for a particular section, which will update the category counters that are displayed on the front page of this section. The administrator may want to run this system periodically to reset these counters.

Update Counter for Total Number of Ads (559)

This option allows the administrator to run the Totalcount system for the Particular section, which will update the counter for the total number of Ads in this section that is displayed on the overall Ads front page. The administrator may want to run this system periodically to reset these counters.

View Ads Log (560)

This option allows the administrator to view the log file that contains all end user actions relating to Ads in the Particular section, including posting, modifying, and deleting Ads

Clear Ads Log (561)

This option allows the administrator to clear the log file that contains all end user actions relating to Ads in the Particular section, including posting, modifying, and deleting Ads.

Create HTML Pages (562)

This option allows the administrator to create HTML pages for the Ads in the Particular section that can be submitted to search engines. This routine will create an HTML summary page that contains links to each Ad. A separate HTML page will also be created for each Ad.

Use of this System by End Users

To use this system, an end user must connect to the installed software by means of a computer with an appropriate communications apparatus over a transmissions medium as illustrated in FIG. 1. The communications apparatus is a physical device, such as a modem, and communication software. The computer can be a personal computer or any digital computing device capable of connecting to and communicating with the Internet or local area network [or a digital network environment].

As illustrated in FIG. 4, all of the system functions are available from the navigation bars that appear either at the top and the bottom of each page in default format, or along the left side of the page.

Above the navigation bar is link to the current section and category, links to overall site home page and home of the systems home page

As illustrated in FIG. 3, all of the system functions are available from the navigation bars 300 that appear either at the top and/or the bottom of each page in default format, or along the left side of the page.

The system is navigated through a multi-tier hierarchical structure compromising a top level sections menu and lower tier categories menu(s). Above the navigation bar are links to overall site home page 305 and the system's home page 306, the current section 307 and category 308. A sections menu is also accessible from various other locations including a pull down menu 350.

The “Search Ads” link (309) takes the administrator or end user back to the front page, so that administrator or end user can search for Ads by section (category) and subcategory. The “Place Ads” link (310) allows the administrator or end user to post new Ads to the system. The “Edit Ads” link (311) allows the administrator or end user to modify Ads, renew Ads, delete Ads, or add or modify multimedia files to Ads. The “My Profile” link (312) allows the administrator or end user to register for an account or to update registration information at any time. The “My Checklist” link (313) will display all Ads that administrator has been added to the checklist (Ads that have marked for future recall and viewing by the system). The “Auto Notify” link (314) allows the administrator or end user to create, modify, or delete a personal search agent that will automatically send new Ads by e-mail that match pre-defined criteria. The “Help” link (315) will cause a pop-up help window to appear. In many areas of the system, this will contain context-sensitive help information related to the topic or page that administrator or end user is on (such as help on placing Ads when the end user is on the Ads posting form).

The process of searching is an integral part of the system. Searching allows an end user to find any assorted array of ADS based on general or specific information contained in the ADS incorporated within the system. How searching is performed in this invention is described below

Beneath or within the navigation bar is a search box (320) that allows the administrator or end user to search for Ads by keywords within any or all sections. Beneath this search box are three more links. To quickly see all Ads, just click on the “Browse Ads” link. (321). For more advanced searches by keywords, including Boolean options, case-sensitive searching, date-range searching, and searching for Ads with photos, click on the “Advanced Search” link (322). For powerful full database searches on specific criteria and within ranges, click on the “Power Search” link (323). The navigation bar includes navigation arrows and buttons below the search results to help end users quickly jump to different sections of the search results without having to keep hitting the “Next” button. The end user can opt to view all AD listings for the section or category or alternatively can construct a search to narrow the current selection.

An end user can browse through Ads in the system by clicking on the “Browse Ads” link that appears just below the keyword search field on any page. The system will display Ads in groups of 10 Ads per page as default or up to the amount specified by the admin.

As further illustrated in FIG. X, to construct a search for distinct ADS, an end user selects the criterion upon which the search is defined. Once the criterion has been selected, an end user submits a request to process the search. By default, the domain of the search is restricted to the current area(s) the end user has selected. However, the end user is given the option of a global search if so desired.

The criteria for searching is as follows:

Searching for Ads by Category (309)

An end user can search for Ads by subcategory at any time by clicking on the “Search” link in the navigation bar. This will take an end user back to the front page, where all of the Ads categories are listed. The number in parentheses listed next to each category indicates the number of Ads that are currently contained within that category. Choose a category by clicking on it. An end user will then see a list of the subcategories within that category, along with the number of Ads contained in each subcategory. Click on one of the subcategories to see all of the Ads that have been posted within that subcategory.

Search For Ads By Keywords (320)

To search for Ads by keywords, an end user can use the search form that appears just underneath or within the navigation bar. Enter the keyword or keywords that an end user want to search on in the input field. An end user can also specify whether an end user want to search in a particular section or in all sections. Then click on the Search! button. The Ads (if any) that matched The search criteria will be displayed on the following page

Advanced Search Form (322)

The Advanced Search form allows an end user to conduct an advanced keyword search. An end user can use Boolean logic to conduct a search for Ads that contain ANY of The keywords, ALL of The keywords, or The keywords as AN EXACT PHRASE. An end user can also specify whether an end user want the search to be case sensitive or not, and how many days ago an end user want to retrieve Ads from. An end user can specify a particular category or search on all categories, and an end user can even specify only Ads that match a specific caption header. An end user can also choose to display only those Ads that contain photos, sound clips, and/or video clips, and an end user also have the option of displaying the Ads fill size or in the short “headlines” format.

Power Search Form (323)

The Power Search form allows an end user to conduct powerful database searches specifying specific criteria, such as the city, number of bedrooms, specific amenities, or other options, depending on the section that an end user is in. An end user can also specify ranges, such as retrieval only of Ads for apartments that cost between $600 and $900 per month, that have at least one but not more than three bedrooms, that are located in a specific city or neighborhood, and that have a fireplace and are near mass transit. An end user can also specify how many Ads should be displayed on each page, whether the search engine should return only exact matches for The search criteria, whether the searches should be case sensitive, and whether to sort in ascending or descending order. In addition, an end user can specify the field to sort by and whether the Ads should be displayed as headlines or in the full size format. An end user can even specify only Ads with photos, sound clips, and/or video clips.

An end user can use the fields on the search form to narrow the search according to the keywords or other criteria that an end user select. If an end user want the broadest possible search, leave all fields blank (although this may result in an inordinately large number of results). Some of the search form options are explained in more detail below.

Exact Match:

An end user can also use the exact match box to narrow the search (for example, if an end user check the exact match box and search for “dog” then only listings with “dog” in them will show up. Listings with “dogs” or “hot dog” in them would not).

Case Sensitive:

If an end user an end user check the case sensitive box, capitalization will matter (for example, if an end user search for “Star”, then listings with the word “star” will not show up).

Date Range Searching:

In these two fields, an end user can search the system for only those Ads posted within a specific date range. To do so, an end user must specify a beginning date and an ending date. The system will return all the entries which fall within that date range. Click on the Popup Calendar buttons to enter the beginning and ending dates.

Price Range:

Search for items within a specific price range. In these two fields, an end user can enter the price range that an end user is interested in. For example, to find items priced between $5,000 and $10,000, type “$5,000” in the “Lowest Acceptable Price” box and “$10,000” in the “Highest Acceptable Price” box.

Age Search:

For people, an end user can also search by age. In these two fields, an end user can enter the age range of people that an end user would like to find. For example, to find people between 25 and 40, type “25” in the “Youngest” box and “40” in the “Oldest” box.

Sort by which Field:

Here, an end user can specify how the system should sort Administrator results.

Reverse Sort?:

Here, an end user can choose to have the system sort in reverse order. For example, if an end user choose to sort by last name and check the Reverse Sort box, the results page will show Ads of people whose last names begin with Z first, and then backwards through the alphabet. For numbers or dates, the system normally shows Ads with the lowest numbers or oldest dates first, so checking the Reverse Sort box will cause it to display Ads with the highest numbers or most recent dates first. End users will be saved from having to wade through all ads, especially older ads that may no longer be relevant.

If a search produces an empty list (i.e. no listings were found given the end user's criterion), the end user receives a notice and is given a choice of redefining the search, beginning a new search, or returning to the next process from which searching was initiated. In response to the search criterion, the computer searches the database. If a search successfully yields any listings, the listings are given to the end user for viewing. When the end user is finished viewing, the end user can either begin a new search, or return to the next process from which searching was initiated.

How an AD listing is viewed in this invention is described further below

Viewing a AD listing with this invention is a simple end user action. As illustrated in FIG. X, the process begins when the end user is given (i.e. from a search) a selection of listings to view. When the end user chooses to view from the selection a particular listing, the listing is retrieved from the AD database. A listing may include any information contributed by the lister with relevant information and detailed descriptions of the AD as well as images, video, audio, the end user can choose to view such in depth information. When the end user has finished viewing the particular listing, the end user can choose to view another listing from the current selection, or return to the next process from which viewing was initiated.

Additional options for viewing ADS are described below.

Ads Per Page:

Here, an end user can choose how many Ads an end user wants the system to display on each page. An end user can choose to display as few as 10 or as many as 200 Ads per page (the default setting is 10). If the search results in more than this number of Ads, the results page will tell an end user Administrator total number of matches and then state “This page will show an end user Ads 1 to 10” (or whatever number an end user chose here). An end user will also be given a button at the bottom of the page that an end user can click on to “See the next 10 hits” (or however many Ads per page an end user chose here). If the results page tells an end user that an end user had more hits than an end user chose to display, an end user can always go back and increase the number of Ads to display per page or narrow The search criteria by filling in more of the search fields so that fewer Ads will be displayed.

Results Format:

Here, an end user can choose whether the Ads should be displayed in the Standard (short) format or the Long format. The standard format gives concise tables that allow an end user to quickly compare key features and sort by these features, as well as links to the full version of each Ads. If an end user wants to see the full version of all Ads right away, then choose the Long format.

My Checklist

The Checklist feature can be used to “mark” certain Ads for future retrieval and display. The Checklist feature is activated by clicking on the “Add/Remove Checklist” checkbox within the Ad that an end user wants to add to her or her Checklist. A popup window will appear informing the end user that this Ad has been successfully checklisted.

Checklisted Ads are retrieved by clicking on the “My Checklist” link in the navigation bar. This page will show an end user either all checklisted Ads from the section that an end user is currently in, or it will show an end user all checklisted Ads from all sections depending on what the administrator has specified. The “View Detailed Ads” link at the bottom of the page can be clicked to see all of these Ads in their full-size format.

If no Ads have been checklisted, a page will be displayed notifying the end user that the Checklist is currently empty. They will be instructed that in order to add items to the Checklist: that they will need to perform a search and to check the checkbox for any Ad that the end user wants added to the Checklist From the search results page.

Ads can be deleted from a checklist by unchecking the “Add/Remove Checklist” checkbox within each Ad that an end user want to remove from Administrator checklist. A popup window then appears informing the end user that this Ad has been successfully removed from the checklist. Ads are automatically removed from the checklist when they expire or are deleted.

Replying to Ads

An end user can reply to a particular Ad by clicking on the Reply to Ads link contained within that Ad. An end user will then see a short form that asks an end user for their e-mail address and the message that an end user want to send to the person who posted this Ad. Once an end user has entered their e-mail address and their message, they click on the Send Reply button. Their message will be sent to this poster, but their e-mail address will not be revealed to them. They will receive an e-mail message from the system informing them of the end users message, and providing the URL where they can retrieve it. When they do so, they will also be given the option of replying to the end users message. Neither party's e-mail address will be revealed during this process, until or unless someone wants to reveal it by entering it in the message box.

Sending Ads to a Friend

An end user can send a particular Ad to another person by clicking on the E-mail This Ad To A Friend link contained within that Ads. An end user will then see a short form that asks an end user for an e-mail address, a friend's e-mail address, a short subject, and the message that an end user want to send to a friend. Once an end user have entered this information, click on the Send This Ad To A Friend button. The Ads will be sent by e-mail to this person, along with the message that an end user entered on this form.

Notifying the Admin of Ads in Violation of System Policies

If an end user feel that a particular Ads is in violation of the system policies of this site, an end user can notify the site administrator by clicking on the “Alert Admin” link contained within that Ads. The following page will contain the Ad again, followed by a form where an end user can enter their name, e-mail address, and a brief message. It is not necessary for an end user to reference the Ad number or category in this area, as that information will automatically be forwarded to the admin when an end user click on the “Alert Admin About This Ad” button.

Viewing Other Ads Posted by an End User

An end user can view other Ads posted by a particular end user within the section that an end user is in or throughout the Ad database. To view other Ads posted by this end user within the same section, click on the “View {section name} Ads Posted By This End user” link contained within the Ads, where {section name } would be the actual name of the section that this Ads is contained in. To view all Ads posted by this end user throughout the system, click on the “View All Ads Posted By This End user” link contained within the Ads

The listing process, as described below, is a set of steps that enables an end user to easily and flexibly list an AD in the database and to set the terms and conditions for the specific listing. The listing process contains automated procedures, where all of the steps are performed and completed electronically, interactively, and in real-time. In order to assist in the process of listing an AD with this invention, an authorized end user begins by creating a new listing or updating information on a current listing.

User Registration

To access many of the features of this system, an end user need to be a registered user. Registration is required to identify and protect the claims and actions of each end user, and to simplify each end user's task by requiring the system to correlate, track, and record the end users actions. If an end user provides the correct username and password, the database is opened, and the end user is given the access and authority to use this system such as editing Ads that the end user has posted. In order to ensure that an end user, and only an end user, are able to edit the Ads that an end user have posted. If an end user haven't already registered, an end user can register at any time by clicking on the My Profile link in the navigation bar (once an end user have registered, an end user can use this link to update Administrator registration details). Otherwise, when an end user perform an activity that requires registration, such as posting a new Ads, an end user will see a logon form.

If an end user is not already registered, click on the “Register For An Account” link. On the following page, please enter the relevant information into the form fields, making sure to carefully read the instructions at the top of the page.

1. name must be one word, using 1-20 characters, with no spaces, using only numbers and letters (a-z, _, or 0-9). Capitalization does matter.

2. password must be one word that contains 4-20 characters.

Required fields are denoted by *. Fields that are not denoted by a * are optional, although filling them in will make it more convenient for an end user when an end user post Ads in the future, as this information will be automatically filled into the Ads posting form for an end user. Once an end user has entered their information, click on the Submit Information button. If an end user have entered the information correctly, an end user will see a page informing an end user that an end user have been successfully added to the end user registration database. Click on the Return to Logon Screen button to login using Administrator new username and password. Once an end user has done so, an end user will be able to access the feature that an end user had selected, such as posting a new Ad.

If the username or password is forgotten, an end user can click on the appropriate link on the logon form to retrieve the username and password. The system will allow an end user to attempt to retrieve information by entering either their username (if an end user forgot their password) or their e-mail address (if an end user forgot name). The username or password is then emailed to the end user.

End users can optionally have the system remember their logon username and password and automatically input their username and password during future visits. This system feature is accomplished through the usage of cookies and is activated by checking the checkbox in the end user registration page.

Updating My Profile

After an end user has registered, an end user profile can be updated at any time by clicking on the My Profile link in the navigation bar. An end user will be prompted to log in. After logging in using the username and password, a form will appear that contains the various end user registration fields. Current information for the end user will be automatically filled in. The username can not be changed at this point, but the password and other registration information can be changed. Make desired changes, and then click on the Update My Account Profile button. Once the system has successfully updated the profile, a “success” page will appear informing the end user.

The username and password is needed to access certain features of this system. If the username or password is forgotten, an end user can click on the appropriate link on the logon form to retrieve the username and password. The system will allow an end user to attempt to retrieve information by entering either Username (if an end user forgot password) or e-mail address (if an end user forgot Username).

Placing or Listing New Ads (STEP )

To place a new Ad, an end user clicks on the Place Ads link from the navigation bar. An end user will be prompted to logon. Once an end user have logged onto the system using Username and password, if an end user isn't already within a section, an end user will be asked to choose the category that an end user want to place Ads in (the page will look similar to the overall front page). Click on the category that an end user want to place Ads in. An end user will then see the Ads posting form. Required fields are indicated by a *. Enter the relevant information for Administrator new Ads and click on the preview button. An end user will be given the opportunity to preview Ads before it is posted. If an end user want to make changes, use the back button on Administrator web browser to go back to the Ads posting form. Otherwise, if an end user is satisfied with the appearance of Ads, click on the Submit button. If Ads is successfully posted to the database, the system will display a “success” page. Once the Ads have been posted, an end user will be given the opportunity to upload one or more multimedia files to be included with the Ads. An ad number is assigned to the AD and displayed to the end user.

The Ad is written to a flat file database in pipe delimited format by default. An alternative embodiment of the database structure is a relational database structure such as MySQL or Oracle.

Add, Modify or Delete Multimedia Files in the Ads (STEP )

This option allows an end user to upload a new multimedia file (photo, sound clip, or video clip) to their Ads or to delete an existing multimedia file associated with these Ads. If an end user has just posted a new Ad, an end user will see the Upload form beneath the message indicating that Ads was successfully posted. Otherwise, if an end user want to add or modify a multimedia file at a later point, an end user can do so by clicking on the “Edit Ads” or “Modify/Renew Ads” link in the navigation bar. If an end user haven't already logged on, an end user will be prompted to do so. Once an end user have logged on, they can click on the “Add/Edit Multimedia Files” link or button. An end user enters the Ad Number for the Ads that an end user want to modify in the box and click on the “Submit” button. Then, click on the Add Multimedia File button if an end user want to add a multimedia file. An end user will then see the Upload form. Click on the Browse button to select the file that an end user want to upload from a local computer. Then click on “Upload Multimedia File to Ads” to include this file with the Ads. To delete a multimedia file that an end user have already uploaded to Ads, click on the “Delete Multimedia File” button. An end user enters the Ad Number in the box and click on the “Display Multimedia Files Associated With This Ad” button to see all photos, sound clips, and video clips that an end user have uploaded to this Ad. Next to each one will be a checkbox. Check the checkbox next to each photo, sound clip, or video clip that an end user want to remove from this Ad and click on the “Delete Checked Multimedia Files” button to remove them.

As described previously, certain limitations on the size and nature of the uploaded multimedia files are set by the administrator.

Modifying an AD (STEP )

To modify an AD, the Edit ADs link from the navigation bar is clicked. An end user will be prompted to logon. Once an end user has logged onto the system using their username and password, if end user is not already within a section, the end user will be asked to choose which section the AD that user want to edit is contained in. User will then be asked whether User want to modify ADs, renew ADs, delete ADs, or upload a photo. To modify the AD, choose the Modify/Renew AD button. On the next page, enter the AD Number in the form and click on the Submit button. If User entered it correctly, the system will display their AD, along with a form that contains all of their current information already filled in. User can simply modify whatever fields User wish to change and then click on the “Submit Modifications” button. Once their AD has been modified, the system will display a successful modification notice.

The flat file database system modifies the ad by writing new files separately by bringing them one line at a time into memory and then renaming these data files as the original file names. Other flat file structures modify the data files by bringing the entire data file into memory and overwriting the old files with the same name. This system in use in this invention greatly reduces the probability of data corruption, reduces the load on the Computer Web Server and is more reliable compared to other flat file database structures.

Deleting ADs (STEP )

To delete their AD, please click on the Delete ADs link from the navigation bar. User will be prompted to logon. If User is not already within a section, User will be asked to specify the section where the AD that User want to delete is contained. Once User have logged onto the system using their username and password, if User aren't already within a section, User will be asked to specify the section where the AD that User want to delete is contained. User will then be prompted for the AD Number of their AD. Enter their AD Number in the form and click on the Submit button. If User entered it correctly, the system will ask User to confirm that User want to delete this AD. If User are sure that User want to delete it, click on the Submit button. Once their AD has been deleted, the system will display a successful deletion notice.

Renewing Ads (STEP )

To renew an AD, the User clicks on the Edit ADs link from the navigation bar. User will be prompted to logon. Once User have logged onto the system using their username and password, if User aren't already within a section, User will be asked to choose which section the AD that User want to edit is contained in. User will then be asked whether User want to modify/renew ADs, delete ADs, or upload a photo. To renew their AD, choose the Modify/Renew AD button. On the next page, enter their AD Number in the form and click on the Submit button. If User entered it correctly, the system will display their AD, along with a form that contains all of their current information already filled in. To renew their AD, go to the Renewal Options sections and check the box if User want to renew their AD. Please note that each AD may be limited to a maximum of a certain amount of renewals by the Administrator. Once an end user has checked this box, click on the “Submit Modifications” button. Once their AD has been renewed, the system will display a successful modification notice.

Auto-Notify

Subscribing to Auto-Notify (1900)

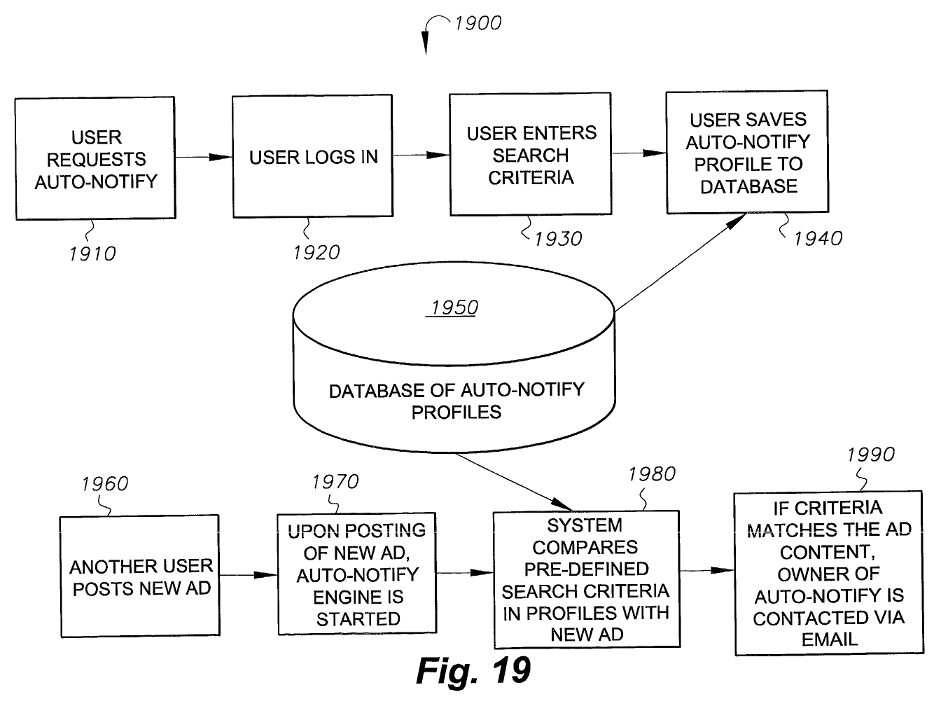

As illustrated in FIG. 19, the Auto-Notify feature allows an end user to set up a personal search agent that will automatically send an end user new Ads that match the keywords or the full database criteria that an end user defines here. An end user will be able to set the number of days that their personal search agent should operate before it automatically expires. To set up an Auto-Notify agent (1910), click on the Auto-Notify link in the navigation bar. From the Auto-Notify options page, click on the Create Agent button. An end user will be prompted to log in. If an end user have already registered, an end user can enter their username and password in the logon form (1920). If an end user haven't already registered, an end user must register in order to use this feature. Once an end user have logged in, specify the keywords and other criteria (1930) (such as the category or type of Ads) that their search agent will use when looking at new Ads. If an end user want to define a sophisticated database search, an end user can do so by clicking on the “Advanced Search” link. An end user will then be able to set up a sophisticated search agent specifying specific criteria, such as the city, number of bedrooms, specific amenities, or other options, depending on the section that an end user is in. An end user can also specify ranges, such as retrieval only of Ads for apartments that cost between $600 and $900 per month, that have at least one but not more than three bedrooms, that are located in a specific city or neighborhood, and that have a fireplace and are near mass transit. The end user then saves his Auto-Notify profile (1940).

The system responds to the receipt of a new ad by storing the new ad in the ad database (1950), and by comparing the new ad to personal search agents (1980), to determine if any of the ads match the search agents. If a match is determined to exist, the system generates output data that includes the new ad, plus delivery data from the matching ads. When new Ads are posted to the system that match the criteria, an end user will be notified by e-mail, including a link to the Ads (1990).

An end user can modify or delete their Auto-Notify search agent at any time by logging on to the system using their username and password (if not already logged in) and clicking on the Auto-Notify link in the navigation bar and then choosing Modify Agent or Delete Agent from the Auto-Notify options page. An end user will need to logon to the system in order to modify or delete their profile.

Affiliate Web Site Signup by End Users (1800)

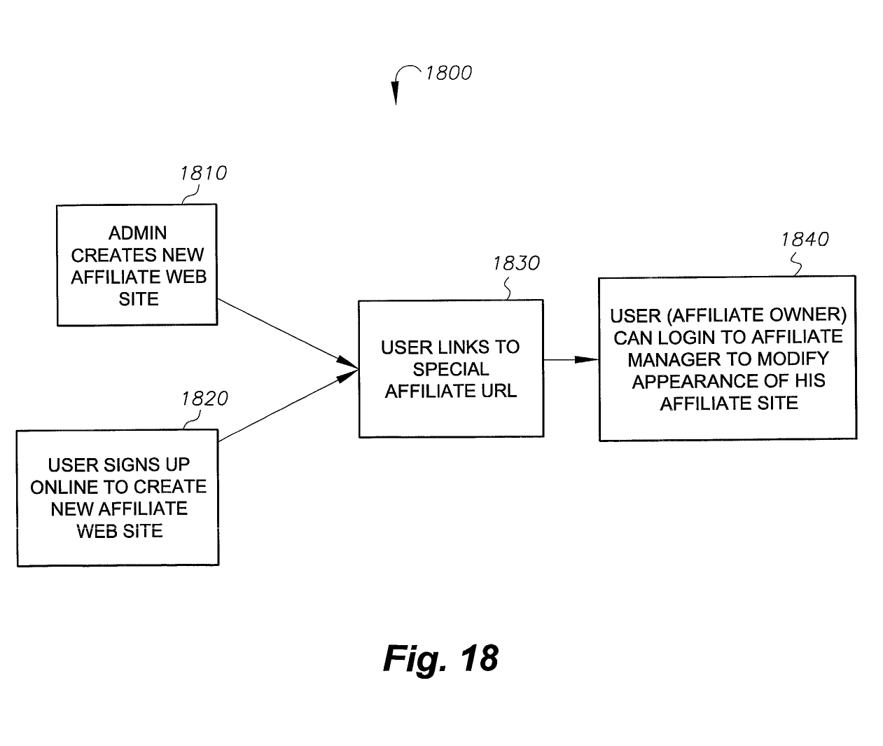

Referring to FIG. 18, If the Administrator has allowed and created affiliate web sites (1810), an end user will see a link for signing up as an affiliate web site (1820). The link will take the end user to a signup form developed by the administrator (1830). After signup, the new affiliate owner can modify the appearance of his site while still accessing one database. (1840).

The significant advantages provided by the present invention are apparent from the above description. The present invention provides a computer based system that is significantly more convenient for administrators, advertisers and end users. In contrast to the conventional newspaper system, the system of the present invention does not require the buyer to scan a large number of ads, or to repeatedly scan new editions of the newspaper. The ability to search all of the information in an ad using conventional text database techniques is combined with the convenience of audio and video output. New ads are instantly available, creating a real time system. Thereafter, whenever a lister places a new ad, an end user may be automatically and immediately notified of the contents of the new ad.

It is important to note that the present invention and all of the features described above are not limited to classified advertising such as the the sale or lease of real estate. Instead, the service and convenience provided by the system are equally applicable for matching the requirements of parties to any transaction involving the display, transfer, matching, swap or exchange of an interest or item, for virtually any type of personal or real property. For example, it should be apparent that the present invention can also be employed in the sale or lease of used automobiles or boats, horses, etc.

While the preferred embodiment of the invention has been illustrated and described, it will be appreciated that various changes can be made therein without departing from the spirit and scope of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

I claim:

1. A computer based system for electronic classified advertising comprising:
a digital information storage device;
means for creating a classified advertisement;
means for electronically publishing a classified advertisement;
means for providing portability of a classified advertisement to a web server;
means for user-defined advertising matching;
means for automatically notifying the user of advertisement responses;
means for electronically updating classified advertisements;
means for selectively altering advertisement response criteria; and
means for providing private messaging response to an electronic advertisement.

2. A method of electronic classified advertising including the steps of:
installing an electronic classified advertising program on a digital information storage device;
electronically defining a classified advertisement;
electronically publishing a classified advertisement;
electronically establishing advertisement response criteria; and
electronically privately and securely responding to electronic classified advertising.
